(19) United States
(12) Patent Application Publication
(10) Pub. No.: US 2022/0393613 A1
(43) Pub. Date: Dec. 8, 2022

(54) POWER SUPPLY SYSTEM AND MOVING BODY

(71) Applicant: HONDA MOTOR CO., LTD., Tokyo (JP)

(72) Inventor: Yoshinari TSUKADA, Saitama (JP)

(21) Appl. No.: 17/805,692

(22) Filed: Jun. 7, 2022

(30) Foreign Application Priority Data
Jun. 8, 2021 (JP) 2021-095864

(51) Int. Cl. H02M 7/5387; B60L 50/51; B60L 50/60

(52) U.S. Cl. CPC H02M 7/5387; B60L 50/51; B60L 50/60; B60L 2210/40

(57) ABSTRACT

A power supply system 1 includes: a variable voltage power supply 7 that outputs power of a variable voltage from a pair of secondary-side input/output terminals 72p and 72n; and power lines 21 and 22 that connect the pair of secondary-side input/output terminals 72p and 72n and a load 4. The first power line 21 is provided with a first switch unit 31 and a third power line 23 that connects both ends of the first switch unit 31, and the third power line 23 is provided with a third switch unit 33, a DC power supply 30, and a second switch unit 32 in series. The fourth power line 24 connects the third power line 23 and the second power line 22. The fourth power line 24 is provided with a fourth diode 34a that allows an output current of the DC power supply 30.

This application is based on and claims the benefit of priority from Japanese Patent Application No. 2021-095864, filed on 8 Jun. 2021, the content of which is incorporated herein by reference.

### BACKGROUND OF THE INVENTION

### Field of the Invention

The present invention relates to a power supply system and a moving body. More specifically, the present invention relates to a power supply system that supplies power to a load and a moving body in which the power supply system is equipped.

### Related Art

For example, an electric vehicle is equipped with a power converter that converts DC power output from a battery into AC power and supplies the AC power to a rotating electric machine connected to drive wheels. Many power converters converts DC power into AC power by switching on/off of switching elements of at least two arms connected in series to a load, and thus switching loss occurring during turn-on and turn-off of the switching elements and steady loss proportional to on-resistance of the switching elements occur (for example, see Patent Document 1).

In the power converter disclosed in Patent Document 1, DC power output from a multi-stage DC chopper circuit is smoothed by a smoothing circuit, and then a loopback circuit makes a half-wave a negative voltage and combines a half-wave of a positive voltage and the half-wave of the negative voltage to generate AC power.
Patent Document 1: PCT International Publication No. WO2019/004015

### SUMMARY OF THE INVENTION

However, since the power converter disclosed in Patent Document 1 uses a multi-stage DC chopper circuit, the number of switching elements increases in proportion to the number of stages of the DC voltage, and thus switching loss also increases accordingly.

Further, since on-resistance of the switching element tends to increase as a withstand voltage of the switching element increases, it is preferable to use a switching element having as low a withstand voltage as possible in order to reduce the steady loss. However, in general, the withstand voltage of the switching element needs to be sufficiently higher than the maximum voltage of the battery in consideration of a surge voltage generated at the time of turn-on or turn-off. For this reason, in the multi-stage DC chopper circuit disclosed in Patent Document 1, it is necessary to increase the withstand voltage of the switching element in proportion to the number of stages of the DC voltage, and thus the steady loss also increases accordingly.

An object of the present invention is to provide a power supply system and a moving body capable of reducing switching loss and steady loss as compared with the related art.

(1) A power supply system (for example, a power supply system 1 or 1A to be described below) according to the present invention includes: a variable voltage power supply (for example, a variable voltage power supply 7, 7A, or 7C to be described below) that outputs power of a variable voltage from a pair of first terminals (for example, a pair of secondary-side input/output terminals 72p and 72n, or 82p and 82n to be described below); a first power line (for example, a first power line 21 to be described below) and a second power line (for example, a second power line 22 to be described below) that connects the pair of first terminals and a load (for example, a load 4 to be described below), the first power line is provided with a first switch (for example, a first switch 31b to be described below) and a third power line (for example, a third power line 23 to be described below) that connects both ends of the first switch, and the third power line is provided with a first DC power supply (for example, a DC power supply 30 or a first DC power supply 30A to be described below), which outputs DC power, and a second switch (for example, a second switch 32b to be described below) which are connected to each other in series.

(2) In this case, preferably, the power supply system includes a fourth power line (for example, a fourth power line 24 to be described below) that connects the variable voltage power supply rather than the first DC power supply and the second switch of the third power line and the second power line, and a third switch (for example, a third switch 33b to be described below) provided closer to the variable voltage power supply of the third power line than a connection point of the fourth power line, and the fourth power line is provided with a fourth diode (for example, a fourth diode 34a to be described below) that allows an output current of the first DC power supply and cuts off a current reverse to the output current.

(3) In this case, preferably, a first diode (for example, a first diode 31a to be described below) and the first switch are connected in parallel to each other, the first diode being configured to allow the output current of the variable voltage power supply and cut off the current reverse to the output current, a third diode (for example, a third diode 33a to be described below) and the third switch are connected in parallel to the third power line, the third diode being configured to cut off the output current of the first DC power supply and allow the current reverse to the output current, and the fourth diode and a fourth switch (for example, a fourth diode 34a to be described below) are connected in parallel to the fourth power line.

(4) In this case, preferably, the power supply system includes a power supply driver (for example, a power supply driver 61 to be described below) that changes a voltage between the pair of first terminals from 0 to a predetermined maximum voltage by operating the variable voltage power supply.

(5) In this case, preferably, the power supply system includes a switch controller (for example, a switch controller 62 to be described below) that controls the first, second, third, and fourth switches based on a system voltage (for example, a system voltage Vout to be described below), which is a voltage between the first and second power lines.

(6) In this case, preferably, during power running in which power in the first and second power lines is supplied to the load, the switch controller turns off the second, third, and fourth switches when changing the system voltage in a range less than a first voltage of the first DC power supply (for example, an output voltage E2 to be described below) and the switch controller turns on the second and third switches and turns off the first and fourth switches when changing the system voltage in a range larger than the first voltage.

(7) In this case, preferably, during the power running, the switch controller switches the second switch from off to on, and then switches the third switch from off to on when raising the system voltage across the first voltage and the switch controller switches the third switch from on to off, and then switches the second switch from on to off when lowering the system voltage across the first voltage.

(8) In this case, preferably, during regeneration in which power in the load is supplied to the first and second power lines, the switch controller turns on the first switch and turns off the second, third, and fourth switches when changing the system voltage in the range less than the first voltage and the switch controller turns on the second switch and turns off the first and fourth switches when changing the system voltage in the range larger than the first voltage.

(9) In this case, preferably, during the regeneration, the switch controller switches the second and fourth switches from off to on and then switches the first and fourth switches from on to off when raising the system voltage across the first voltage, and the switch controller switches the first and fourth switches from off to on and then switches the second and fourth switches from on to off when lowering the system voltage across the first voltage.

(10) In this case, preferably, a fifth diode (for example, a fifth diode 35a to be described below) and a fifth switch (for example, a fifth switch 35b to be described below) are connected in parallel to the first power line closer to the load than a connection point of the first switch and the third power line, the fifth diode being configured to allow the output current of the variable voltage power supply and cut off the current reverse to the output current, the first power line is provided with a fifth power line (for example, a fifth power line 25 to be described below) that connects the fifth diode and both ends of the fifth switch, and a second DC power supply (for example, a second DC power supply 39 to be described below) for outputting DC power and a sixth switch (for example, a sixth switch 36b to be described below) are connected in series to the fifth power line.

(11) In this case, preferably, the power supply system includes a sixth power line (for example, a sixth power line 26 to be described below) that connects the variable voltage power supply of the fifth power line rather than the second DC power supply and the sixth switch and the first DC power supply and the third switch of the third power line, a seventh diode (for example, a seventh diode 37a to be described below) and a seventh switch (for example, a seventh switch 37b to be described below) are connected in parallel to the fifth power line closer to the variable voltage power supply than a connection point with the sixth power line, the seventh diode being configured to cut off the output current of the second DC power supply and allow the current reverse to the output current, and an eighth diode (for example, an eighth diode 38a to be described below) and an eighth switch (for example, an eighth switch 38b to be described below) are connected in parallel to the sixth power line, the eighth diode being configured to allow the output current of the second DC power supply and cut off the current reverse to the output current.

(12) A moving body (for example, a vehicle V to be described below) according to the present invention includes an AC rotating electrical machine (for example, an AC rotating electrical machine M to be described below) that generates a propulsive force, a U-phase power supply (for example, a U-phase power supply 3U to be described below) that is the power supply system according to any one of (1) to (11) described above, a V-phase power supply (for example, a V-phase power supply 3V to be described below) that is the power supply system according to any one of (1) to (11) described above, and a W-phase power supply (for example, a W-phase power supply 3W to be described below) that is the power supply system according to any one of (1) to (11) described above, the U-phase power supply is connected to both ends of a U-phase leg (for example, a U-phase leg 9U to be described below) connected to a U-phase of the AC rotating electrical machine, the V-phase power supply is connected to both ends of a V-phase leg (for example, a V-phase leg 9V to be described below) connected to a V-phase of the AC rotating electrical machine, and the W-phase power supply is connected to both ends of a W-phase leg (for example, a W-phase leg 9W to be described below) connected to a W-phase of the AC rotating electrical machine.

(1) The power supply system according to the present invention includes the variable voltage power supply, the first and second power lines that connect the pair of first terminals of the variable voltage power supply and the load, the first switch provided on the first power line, the third power line that is connected to the first power line so as to bypass the first switch, and the first DC power supply and the second switch that are connected in series to the third power line. According to the present invention, when the system voltage, which is the voltage between the first and second power lines, is changed in a range less than the first voltage of the first DC power supply (when a low voltage is applied), the second switch is turned off, whereby the system voltage can be changed only by the output of the variable voltage power supply. Further, according to the present invention, when the system voltage is changed in a range more than the first voltage (when a high voltage is applied), the first switch is turned off, and the variable voltage of the variable voltage power supply is superimposed on the DC voltage of the first DC power supply, whereby the system voltage can be changed in the range larger than the first voltage. Therefore, according to the present invention, since it is not necessary to operate the switch in order to change the voltage applied to the load both when the low voltage is applied and when the high voltage is applied, it is not necessary to increase the number of switches in a case of making the voltage multiple stages. For this reason, it is possible to reduce the number of switches as compared with the case of making the voltage multiple stages by the multi-stage DC chopper circuit as disclosed in Patent Document 1, for example, and thus it is possible to reduce switching loss and steady loss to that extent.

Further, according to the present invention, as described above, it is not necessary to operate the switch to change the voltage during the high-voltage application, and thus it is not necessary to consider a surge voltage during the high-voltage application in a case of designing the withstand voltage of the switch included in the power supply system. Therefore, according to the present invention, it is possible to lower the withstand voltage of the switch included in the power supply system as compared with the case of making the voltage multiple stages by the multi-stage DC chopper circuit as disclosed in Patent Document 1, for example, and thus it is possible to reduce steady loss in the switch and to further reduce costs of the switch.

Further, according to the present invention, as described above, it is not necessary to operate the switching circuit to change the voltage during the high-voltage application, and thus a high frequency component of the voltage applied to the load can be reduced, whereby it is also possible to reduce iron loss.

(2) The power supply system according to the present invention includes the fourth power line that connects the variable voltage power supply rather than the first DC power supply and the second switch of the third power line and the second power line, the third switch provided closer to the variable voltage power supply of the third power line than the connection point with the fourth power line, and the fourth diode provided on the fourth power line. According to the present invention, the fourth power line and the fourth diode are provided at these positions, and the variable voltage power supply and the first DC power supply can be connected in parallel to the load (hereinafter, also referred to as “overlap stage”) only at the moment when the variable voltage of the variable voltage power supply becomes equal to the first voltage of the first DC power supply when the system voltage is changed across the first voltage, that is, when the power circuit formed by the power supply system is switched between the one-stage connection in which only the variable voltage power supply is connected to the load and the two-stage connection in which the variable voltage power supply and the first DC power supply are connected in series to the load, whereby it is possible to prevent a large change in the system voltage at the time of switching between the one-stage connection and the two-stage connection.

(3) In the power supply system according to the present invention, the first diode and the first switch are connected in parallel to the first power line, the third diode and the third switch are connected in parallel to the third power line, and the fourth diode and the fourth switch are connected in parallel to the fourth power line. According to the present invention, it is possible to prevent the current from flowing in an unintended direction during power running and during regeneration of the power supply system.

(4) The power supply system according to the present invention includes the power supply driver that changes the voltage between the pair of first terminals from 0 to a predetermined maximum voltage by operating the variable voltage power supply. According to the present invention, it is possible to shape the waveform of the variable voltage of the power output from the variable voltage power supply by the power supply driver into a preferred waveform, and thus it is possible to supply the AC power having the preferred waveform to the load without operating the power supply system and the switch included in the switching circuit connected between the power supply system and the load while the variable voltage is applied to the load.

(5) According to the power supply system of the present invention, the switch controller controls the first to fourth switches based on the system voltage, and thus it is possible to switch the power circuit formed by the power supply system between the one-stage connection and the two-stage connection at an appropriate timing such that the system voltage is not disturbed.

(6) In the power supply system according to the present invention, the switch controller turns off the second, third, and fourth switches when changing the system voltage in the range less than the first voltage during power running, whereby only the variable voltage power supply is connected to the load (that is, one-stage connection), and the power output from the variable voltage power supply can be supplied to the load. Further, when the system voltage is changed in the range larger than the first voltage during power running, the switch controller turns the second and third switches and turns off the first and fourth switches, whereby the variable voltage power supply and the first DC power supply are connected in series to the load (that is, two-stage connection), and the power output from these power supplies can be supplied to the load.

(7) In the power supply system according to the present invention, the switch controller switches the second switch from off to on, and then switches the third switch from off to on when raising the system voltage across the first voltage during power running, and the switch controller switches the third switch from on to off, and then switches the second switch from on to off when lowering the system voltage across the first voltage during power running. Thus, during switching between the one-stage connection and the two-stage connection, an overlap state can be realized instantaneously, and thus a large change in system voltage can be prevented during the switching between the one-stage connection and the two-stage connection.

(8) In the power supply system according to the present invention, the switch controller turns on the first switch and turns off the second, third, and fourth switches when changing the system voltage in the range less than the first voltage during regeneration, whereby only the variable voltage power supply is connected to the load (that is, one-stage connection), and regenerative power can be supplied to the variable voltage power supply. Further, the switch controller turns on the second switch and turns off the first and fourth switches when changing the system voltage in the range larger than the first voltage during regeneration, whereby the variable voltage power supply and the first DC power supply are connected in series to the load (that is, two-stage connection), and the regenerative power can be divided to be supplied to the first DC power supply and the variable voltage power supply.

(9) In the power supply system according to the present invention, the switch controller switches the second and fourth switches from off to on and then switches the first and fourth switches from on to off when raising the system voltage across the first voltage during regeneration, and the switch controller switches the first and fourth switches from off to on and then switches the second and fourth switches from on to off when lowering the system voltage across the first voltage during regeneration. Thus, during switching between the one-stage connection and the two-stage connection, an overlap state can be realized instantaneously, and thus a large change in system voltage can be prevented during the switching between the one-stage connection and the two-stage connection.

(10) The power supply system according to the present invention includes the fifth diode and the fifth switch that are connected in parallel to the first power line closer to the load than the connection point of the first switch and the third power line, the fifth power line connected to the first power line so as to bypass the fifth diode and the fifth switch, and the second DC power supply and the sixth switch connected in series to the fifth power line. According to the present invention, when the sixth switch is turned on, since the variable voltage power supply, the first DC power supply, and the second DC power supply are connected in series to the load (three-stage connection), the number of stages of the system voltage can be further increased.

(11) The power supply system according to the present invention includes the sixth power line that connects the variable voltage power supply of the fifth power line rather than the second DC power supply and the sixth switch and the first DC power supply and the third switch of the third power line, the seventh diode and the seventh switch that are connected in parallel to the fifth power line, and the eighth diode and the eighth switch that are connected in parallel to the sixth power line. According to the present invention, it is possible to prevent the current from flowing in an unintended direction during power running and during regeneration of the power supply system.

(12) The moving body according to the present invention includes the AC rotating electrical machine that generates the propulsive force and the U-phase power supply, the V-phase power supply, and the W-phase power supply that are the power supply system capable of being switching between the one-stage connection and the two-stage connection as described above. In the present invention, the U-phase power supply is connected to both ends of the U-phase leg connected to the U-phase of the AC rotating electrical machine, the V-phase power is connected to both ends of the V-phase leg connected to the V-phase of the AC rotating electrical machine, and the W-phase power supply is connected to both ends of the W-phase leg connected to the W-phase of the AC rotating electrical machine. According to the present invention, as in the invention according to (1) described above, since it is not necessary to increase the number of arm switches included in the legs of the respective phases when the voltage is increased in multiple stages, the switching loss and the steady loss in the legs of the respective phases can be reduced accordingly. Further, according to the present invention, as in the invention according to (1) described above, since the withstand voltage of the switches included in the power supplies of the respective phases can be lowered, the steady loss in the switches can be lowered, and the costs of the switches can also be reduced. Further, according to the present invention, as in the invention according to (1) described above, since it is not necessary to operate the arm switches included in the legs of the respective phases in order to change the voltage during the high-voltage application (during two-stage connection or during three-stage connection), the high frequency component of the voltage applied to the AC rotating electrical machine can be reduced, whereby the iron loss can also be reduced.

### BRIEF DESCRIPTION OF THE DRAWINGS

FIG. 1 is a diagram showing a circuit configuration of a power supply system according to a first embodiment of the present invention;

FIG. 2 is a diagram showing an example of a circuit configuration of a variable voltage power supply;

FIG. 3 is a functional block diagram showing a configuration of a power supply driver;

FIG. 4 is a diagram schematically showing a path of a current realized in a multi-stage voltage power supply;

FIG. 5 is a table showing a relationship between states of first to fourth switch units and current paths realized in the multi-stage voltage power supply;

FIG. 6 is an example of a time chart showing a change in voltage of each portion of a power supply system during power running of a load;

FIG. 7 is a diagram showing a circuit configuration of a variable voltage power supply of a power supply system according to a second embodiment of the present invention;

FIG. 8A is a diagram showing a first example of a rear-stage converter;

FIG. 8B is a diagram showing a second example of a rear-stage converter;

FIG. 9 is a diagram showing a circuit configuration of a power supply system according to a third embodiment of the present invention;

FIG. 10 is a diagram schematically showing current paths realized in the multi-stage voltage power supply;

FIG. 11 is a table showing a relationship between states of first to eighth switch units and current paths realized in the multi-stage voltage power supply;

FIG. 12 is a diagram showing a circuit configuration of a vehicle according to a fourth embodiment of the present invention; and

FIG. 13 is a diagram showing another example of a circuit configuration of the variable voltage power supply.

### DETAILED DESCRIPTION OF THE INVENTION

### First Embodiment

A power supply system according to a first embodiment of the present invention will be described below with reference to the drawings.

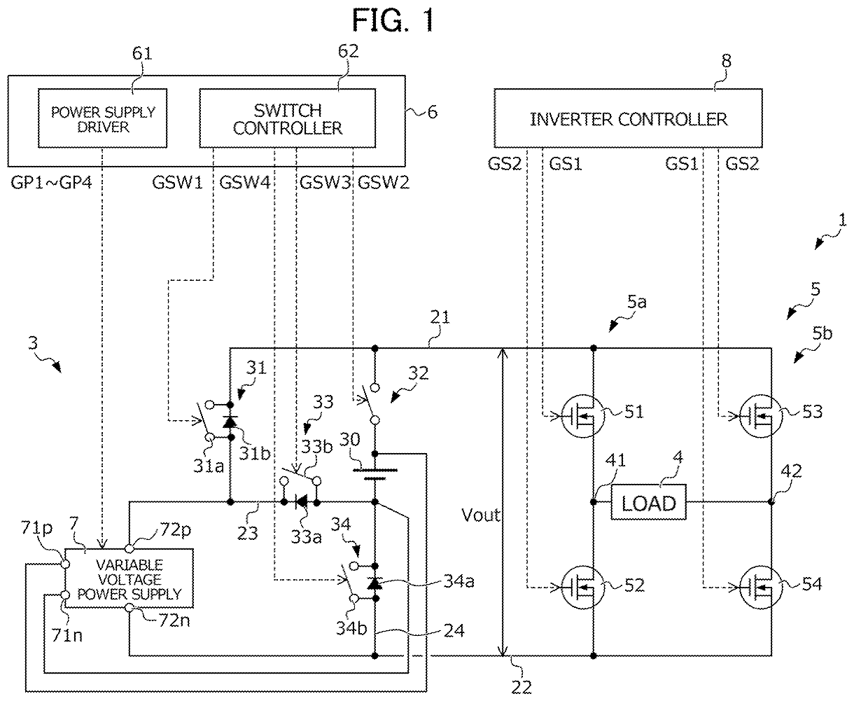

FIG. 1 is a diagram showing a circuit configuration of a power supply system 1 according to the present embodiment. The power supply system 1 includes a multi-stage voltage power supply 3 that outputs DC power of a multi-stage voltage to a first power line 21 and a second power line 22, an inverter circuit 5 that connects power lines 21 and 22 with a load 4, a multi-stage voltage power supply controller 6 that controls the multi-stage voltage power supply 3, and an inverter controller 8 that controls the inverter circuit 5. The power supply system 1 operates the multi-stage voltage power supply 3 and the inverter circuit 5 with the controllers 6 and 8 to convert the DC power output from the multi-stage voltage power supply 3 to the power lines 21 and 22 into AC power and supply it to the load 4, or to convert the AC power output from the load 4 into DC power and supply it to the multi-stage voltage power supply 3.

In the following description, a case will be described in which the load 4 is an AC rotating electrical machine that converts AC power supplied from the multi-stage voltage power supply 3 through the inverter circuit 5 into mechanical energy of a rotating shaft during power running, and that converts the mechanical energy of the rotating shaft into AC power and output it to the multi-stage voltage power supply 3 through the inverter circuit 5 during regeneration, but the present invention is not limited thereto.

The inverter circuit 5 includes two legs 5a and 5b that are used to connect the first power line 21 and the second power line 22. The a-phase leg 5a includes an a-phase upper arm switching element 51 and an a-phase lower arm switching element 52 that are connected in series from the first power line 21 toward the second power line 22 in this order. The b-phase leg 5b is connected to the power lines 21 and 22 so as to be in parallel with the a-phase leg 5a. The b-phase leg 5b includes a b-phase upper arm switching element 53 and a b-phase lower arm switching element 54 that are connected in series from the first power line 21 toward the second power line 22 in this order.

A first input/output terminal 41 of the load 4 is connected to a midpoint of the a-phase leg 5a, that is, a connection point between the a-phase upper arm switching element 51 and the a-phase lower arm switching element 52. In other words, the a-phase upper arm switching element 51 connects the first power line 21 and the first input/output terminal 41 of the load 4, and the a-phase lower arm switching element 52 connects the second power line 22 and the first input/output terminal 41 of the load 4. Further, a second input/output terminal 42 of the load 4 is connected to a midpoint of the b-phase leg 5b, that is, a connection point between the b-phase upper arm switching element 53 and the b-phase lower arm switching element 54. In other words, the b-phase upper arm switching element 53 connects the first power line 21 and the second input/output terminal 42 of the load 4, and the b-phase lower arm switching element 54 connects the second power line 22 and the second input/output terminal 42 of the load 4.

Each of these switching elements 51, 52, 53, and 54 is switched on or off according to on/off of a gate drive signal GS1 or GS2 input from the inverter controller 8. More specifically, the a-phase upper arm switching element 51 and the b-phase lower arm switching element 54 are switched on or off according to on/off of the gate drive signal GS1 input from the inverter controller 8, and the b-phase upper arm switching element 53 and the a-phase lower arm switching element 52 are switched on or off according to on/off of the gate drive signal GS2 input from the inverter controller 8. In the present embodiment, a case will be described in which an N-channel MOSFET including a body diode, which allows a current from a source to a drain, is used as these switching elements 51 to 54, but the present invention is not limited thereto. As these switching elements 51 to 54, a known switching element such as an IGBT or a JFET may be used in addition to the MOSFET.

Further, as will be described below, these switching elements 51 to 54 do not necessary to perform switching control at the time of high-voltage output of the multi-stage voltage power supply 3.

Drains of the upper arm switching elements 51 and 53 are connected to the first power line 21, and sources of the upper arm switching elements 51 and 53 are connected to the first input/output terminal 41 and the second input/output terminal 42 of the load 4, respectively. Sources of the lower arm switching elements 52 and 54 are connected to the second power line 22, drains of the lower arm switching elements 52 and 54 are connected to the first input/output terminal 41 and the second input/output terminal 42 of the load 4, respectively. Thereby, the body diode of each of the switching elements 51 to 54 acts as a freewheeling diode.

The multi-stage voltage power supply 3 includes: a variable voltage power supply 7 that outputs DC power of a variable voltage that fluctuates in a predetermined cycle; a first power line 21 and a second power line 22 that connects the variable voltage power supply 7 and the load 4; a first switch unit 31 provided on the first power line 21; a third power line 23 that is connected to the first power line 21 so as to bypass the first switch unit 31; a DC power supply 30, a second switch unit 32, and a third switch unit 33 that are provided in series on the third power line 23; and a fourth power line 24 that connects the second power line 21 and the third power line 23. The multi-stage voltage power supply 3 is a three-level DC voltage power supply that can output DC voltages of three stages of 0 [V], E1 [V] (hereinafter, a variable voltage output from the variable voltage power supply 7 being referred to as E1), and E1+E2 [V] (hereinafter, an output voltage of the DC power supply 30 being referred to as E2), according to a circuit configuration to be described below.

The multi-stage voltage power supply controller 6 includes a power supply driver 61 that changes the variable voltage E1 from 0 to a predetermined maximum voltage by operating the variable voltage power supply 7, and a switch controller 62 that controls switch units 31 to 34 based on a system voltage Vout which is a voltage between the power lines 21 and 22.

The DC power supply 30 is connected to the third power line 23 with a positive electrode on the load 4 and a negative electrode on the variable voltage power supply 7. The DC power supply 30 outputs the DC power of the output voltage E2 to the third power line 23. In the present embodiment, a case will be described in which the DC power supply 30 is a secondary battery capable of performing both of discharging during which chemical energy is converted into electric energy and charging during which electric energy is converted into chemical energy, but the present invention is not limited thereto. For example, as the DC power supply 30, a fuel cell may be used that generates electricity when an oxygen-containing oxidant gas and a hydrogen gas are supplied.

The variable voltage power supply 7 includes, for example, a pair of primary-side input/output terminals 71p and 71n and a pair of secondary-side input/output terminals 72p and 72n that are isolated from each other, and an isolated bidirectional DC/DC converter is used that can bidirectionally input and output DC power between the pair of primary-side input/output terminals 71p and 71n and the pair of secondary-side input/output terminals 72p and 72n. As shown in FIG. 1, the pair of secondary-side input/output terminals 72p and 72n of the variable voltage power supply 7 are connected to the first power line 21 and the second power line 22, respectively. Therefore, during power running of the load 4, the variable voltage power supply 7 transforms the DC power in the pair of primary-side input/output terminals 71p and 71n and outputs the power of the variable voltage E1 from the pair of secondary-side input/output terminals 72p and 72n, and during regeneration of the load 4, the variable voltage power supply 7 transforms the DC power in the pair of secondary-side input/output terminals 72p and 72n and outputs the DC power from the pair of primary-side input/output terminals 71p and 71n.

Further, as shown in FIG. 1, the pair of primary-side input/output terminals 71p and 71n of the variable voltage power supply 7 are connected to both positive and negative electrodes of the DC power supply 30. More specifically, the primary-side positive electrode input/output terminal 71p of the variable voltage power supply 7 is connected to the positive electrode of the DC power supply 30, and the primary-side negative electrode input/output terminal 71n of the variable voltage power supply 7 is connected to the negative electrode of the DC power supply 30. In the present embodiment, the case has been described in which the pair of primary-side input/output terminals 71p and 71n are connected to both the positive and negative electrodes of the DC power supply 30, but the present invention is not limited thereto. The pair of primary-side input/output terminals 71p and 71n of the variable voltage power supply 7 may be connected to both positive and negative electrodes of a power supply different from the DC power supply 30.

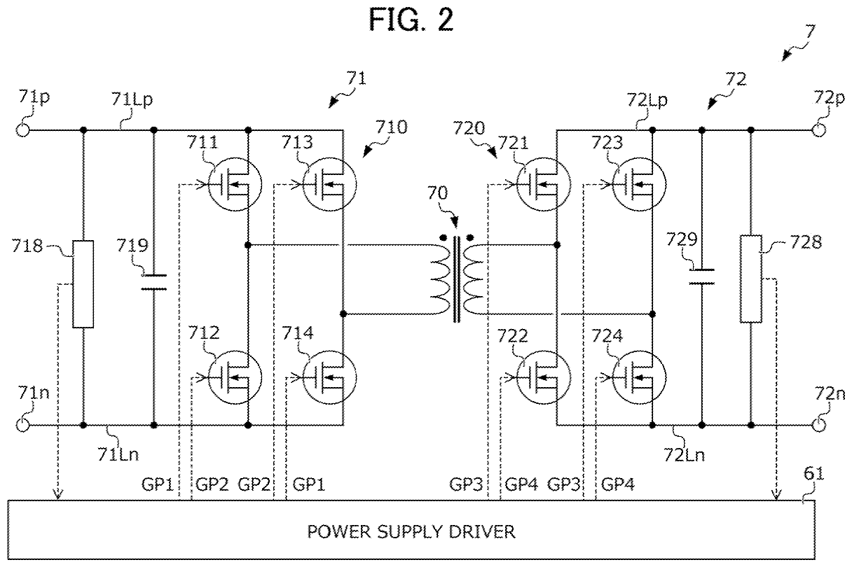

Next, a more detailed configuration of the variable voltage power supply 7 will be described with reference to FIG. 2. FIG. 2 is a diagram showing an example of the circuit configuration of the variable voltage power supply 7. FIG. 2 shows a case where the variable voltage power supply 7 is a so-called full bridge isolated bidirectional DC/DC converter. In the following description, a DC/DC converter of a voltage type will be described as an example, but the present invention is not limited thereto. The DC/DC converter may be a current type.

The variable voltage power supply 7 shown in FIG. 2 includes an insulation transformer 70 having a primary coil and a secondary coil, a primary-side circuit 71 in which the primary side of the insulation transformer 70 is connected to the pair of primary-side input/output terminals 71p and 71n, and a secondary-side circuit 72 in which the secondary side of the insulation transformer 70 is connected to the pair of secondary-side input/output terminals 72p and 72n.

The primary-side circuit. 71 includes a positive electrode power line 71Lp connected to the primary-side positive electrode input/output terminal 71p, a negative electrode power line 71Ln connected to the primary-side negative electrode input/output terminal 71n, a primary-side full bridge circuit 710 in which these power lines 71Lp and 71Ln are connected to the primary coil of the insulation transformer 70, and a primary-side voltage sensor 718 and a smoothing capacitor 71.9 that are connected to each other in parallel between the positive electrode power line 71Lp and the negative electrode power line 71Ln. The primary-side voltage sensor 718 transmits a voltage detection signal corresponding to a voltage between the power lines 71Lp and 71Ln to the power supply driver 61.

The primary-side full bridge circuit 710 includes four switching elements 711, 712, 713, and 714 constituting the full bridge circuit on the primary side of the insulation transformer 70. Each of these switching elements 711 to 714 is switched on or off according to on/off of gate drive signals GP1 and GP2 input from the power supply driver 61. More specifically, the switching elements 711 and 714 are switched on or off according to on/off of the gate drive signal GP1 input from the power supply driver 61, and the switching elements 712 and 713 are switched on or off according to on/off of the gate drive signal GP2 input from the power supply driver 61. In the present embodiment, a case has been described in which an N-channel MOSFET including the body diode, which allows a current from a source to a drain, is used as the switching elements 711 to 714, but the present invention is not limited thereto. As these switching elements 711 to 714, a known switching element such as an IGBT or a JFET may be used in addition to the MOSFET.

Drains of the switching elements 711 and 713 are connected to the positive electrode power line 71Lp, and sources of the switching elements 711 and 713 are connected to both ends of the primary coil of the insulation transformer 70, respectively. Sources of the switching elements 712 and 714 are connected to the negative electrode power line 71Ln, and drains of the switching elements 712 and 714 are connected to both ends of the primary coil of the insulation transformer 70, respectively.

The secondary-side circuit 72 includes a positive electrode power line 72Lp connected to the secondary-side positive electrode input/output terminal 72p, a negative electrode power line 72Ln connected to the secondary-side negative electrode input/output terminal 72n, a secondary-side full bridge circuit 720 in which these power lines 72Lp and 72Ln are connected to the secondary coil of the insulation transformer 70, and a secondary-side voltage sensor 728 and a smoothing capacitor 729 that are connected to each other in parallel between the positive electrode power line 72Lp and the negative electrode power line 72Ln. The secondary-side voltage sensor 728 transmits a voltage detection signal corresponding to a voltage between the power lines 72Lp and 72Ln to the power supply driver 61.

The secondary-side full bridge circuit 720 includes four switching elements 721, 722, 723, and 724 constituting the full bridge circuit on the secondary side of the insulation transformer 70. Each of these switching elements 721 to 724 is switched on or off according to on/off of gate drive signals GP3 and GP4 input from the power supply driver 61. More specifically, the switching elements 721 and 724 are switched on or off according to on/off of the gate drive signal GP3 input from the power supply driver 61, and the switching elements 722 and 723 are switched on or off according to on/off of the gate drive signal GP4 input from the power supply driver 61. In the present embodiment, a case has been described in which an N-channel MOSFET including the body diode, which allows a current from a source to a drain, is used as the switching elements 721 to 724, but the present invention is not limited thereto. As these switching elements 721 to 724, a known switching element such as an IGBT or a JFET may be used in addition to the MOSFET.

Drains of the switching elements 721 and 723 are connected to the positive electrode power line 72Lp, and sources of the switching elements 721 and 723 are connected to both ends of the secondary coil of the insulation transformer 70, respectively. Sources of the switching elements 722 and 724 are connected to the negative electrode power line 72Ln, and drains of the switching elements 722 and 724 are connected to both ends of the secondary coil of the insulation transformer 70, respectively.

During power running of the load 4, the variable voltage power supply 7 as described above turns on/off the switching elements 711, 712, 713, and 714 of the primary-side circuit 71 by the gate drive signals GP1 and GP2 input from the power supply driver 61 and causes the secondary-side circuit 72 to operate as a rectifier circuit by the body diode of the switching elements 721, 722, 723, and 724, thereby transforming the DC power in the pair of primary-side input/output terminals 71p and 71n and outputting the power of the variable voltage E1 from the pair of secondary-side input/output terminals 72p and 72n. Further, during regeneration of the load 4, the variable voltage power supply 7 turns on/off the switching elements 721, 722, 723, and 724 of the secondary-side circuit 72 by the gate drive signals GP3 and GP4 input from the power supply driver 61 and causes the primary-side circuit 71 to operate as a rectifier circuit by the body diode of the switching elements 711, 712, 713, and 714, thereby transforming the DC power in the pair of secondary-side input/output terminals 72p and 72n and outputting the DC power from the pair of primary-side input/output terminals 71p and 71n.

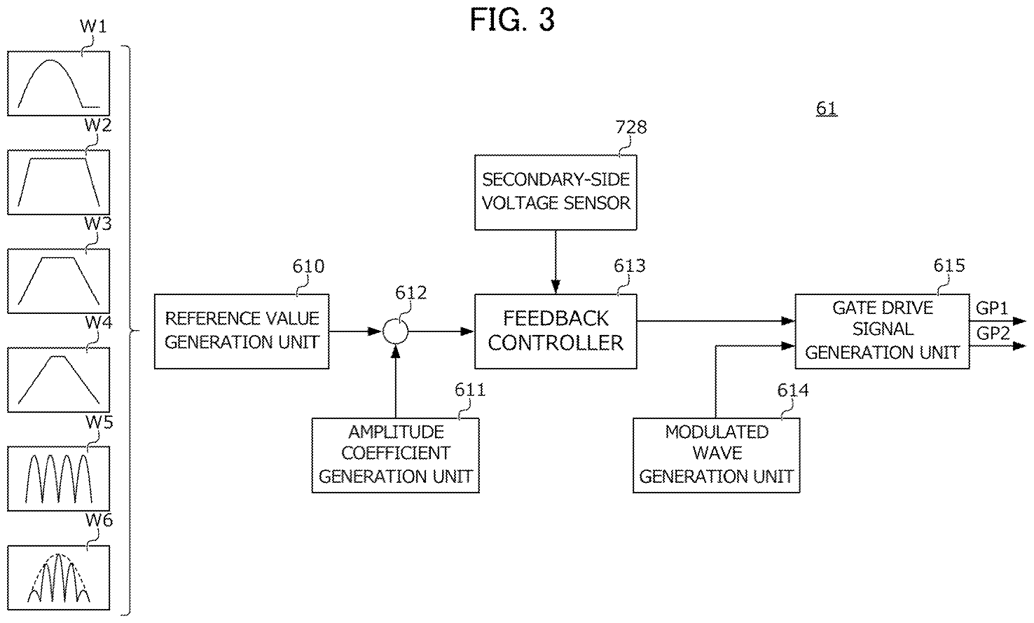

FIG. 3 is a functional block diagram showing a configuration of the power supply driver 61. More specifically, FIG. 3 shows only portions of the power supply driver 61, which operates the variable voltage power supply 7, related to the operation of the variable voltage power supply 7 during power running of the load 4 in particular.

The power supply driver 61 includes a reference value generation unit 610, an amplitude coefficient generation unit 611, a multiplication unit 612, a feedback controller 613, a modulated wave generation unit 614, and a gate drive signal generation unit 615. During power running of the load 4, the power supply driver 61 inputs the gate drive signals GP1 and GP2, which are generated using the reference value generation unit 610, the amplitude coefficient generation unit 611, the multiplication unit 612, the feedback controller 613, the modulated wave generation unit 614, and the gate drive signal generation unit 615, to the switching elements 711 to 714 of the primary-side circuit 71 of the variable voltage power supply 7, and operates these switching elements 711 to 714, thereby controlling a waveform of the variable voltage E1 output from the pair of secondary-side input/output terminals 72p and 72n.

The reference value generation unit 610 selects one of plurality of predetermined reference waveform profile data W1 to W6, calculates a control reference value based on the selected reference waveform profile data, and outputs the calculated control reference value to the multiplication unit 612. These reference waveform profile data W1 to W6 serve as a norm of the waveform of the variable voltage E1 output from the pair of secondary-side input/output terminals 72p and 72n during power running of the load 4.

The amplitude coefficient generation unit 611 outputs a preset amplitude coefficient to the multiplication unit 612. The amplitude coefficient is a coefficient that is used to determine an amplitude of the variable voltage E1, that is, the maximum value of the variable voltage E1, and is determined between 0 to 1.

The multiplication unit 612 multiplies the control reference value output from the reference value generation unit 610 by the amplitude coefficient output from the amplitude coefficient generation unit 611 to calculate a target value of the variable voltage E1, and outputs the target value to the feedback controller 613.

The feedback controller 613 generates a correction signal according to a known feedback control algorithm (for example, a PID control rule) such that there is no deviation between the voltage value detected by the secondary-side voltage sensor 728 and the target value output from the multiplication unit 612, and outputs the correction signal to the gate drive signal generation unit 615.

The modulated wave generation unit 614 generates a modulated wave signal according to known modulated wave generation algorithms (for example, a PWM modulation algorithm, a PDM modulation algorithm, and a Δ-Σ modulation algorithm), and outputs the modulated wave signal to the gate drive signal generation unit 615.

The gate drive signal generation unit 615 generates, based on a comparison between the correction signal output from the feedback controller 613 and the modulated wave signal output from the modulated wave generation unit 614, the gate drive signal GP1 and the gate drive signal GP2, and inputs the generated signals to the switching elements 711 to 714, wherein the gate drive signal GP1 is used for driving the switching elements 711 and 714 of the primary-side circuit 71, and the gate drive signal GP2 is the gate drive signal for driving the switching elements 712 and 713 of the primary-side circuit 71 and has on/off inverted to that of the gate drive signal GP1.

The power supply driver 61 generates the gate drive signals GP1 and GP2 according to the procedure described above during power running of the load 4, and outputs the variable voltage E1 of the waveform selected by the reference value generation unit 610 from the pair of secondary-side input/output terminals 72p and 72n.

Next, returning to FIG. 1, the first power line 21 is provided with the first switch unit 31. The first switch unit 31 includes a first diode 31a and a first switch 31b that are connected to the first power line 21 in parallel. The first diode 31a allows the output current of the variable voltage power supply 7 and cuts off a current in a direction opposite to the output current. The first switch 31b is switched on or off according to a gate drive signal GSW1 input from the switch controller 62. In FIG. 1, the first diode 31a and the first switch 31b constituting the first switch unit 31 are shown as separate circuit elements for ease of understanding, but the present invention is not limited thereto. The first switch unit 31 may be replaced with a known switching element such as an MOSFET, an IGBT, or a JFET including a body diode.

The third power line 23 is connected to both ends of the first switch unit 31. More specifically, one end side of the third power line 23 is connected to the first power line 21 between the first switch unit 31 and the variable voltage power supply 7, and the other end side of the third power line 23 is connected to the first power line 21 closer to the load 4 than the first switch unit 31.

The third switch unit 33, the DC power supply 30, and the second switch unit 32 are connected in series to the third power line 23 in order from the variable voltage power supply 7 toward the load 4. More specifically, the third switch unit 33 is connected to the third power line 23 closer to the negative electrode of the DC power supply 30, and the second switch unit 32 is connected to the third power line 23 closer to the positive electrode of the DC power supply 30.

The third switch unit 33 includes a third diode 33a and a third switch 33b that are connected in parallel to the third power line 23. The third diode 33a cuts off the output current of the DC power supply 30 and allows a current in the direction opposite to the output current. The third switch 33b is switched on or off according to a gate drive signal GSW3 input from the switch controller 62. In FIG. 1, the third diode 33a and the third switch 33b constituting the third switch unit 33 are shown as separate circuit elements for ease of understanding, but the present invention is not limited thereto. The third switch unit 33 may be replaced with a known switching element as in the first switch unit 31.

The second switch unit 32 is switched on or off according to a gate drive signal GSW2 input from the switch controller 62. The second switch unit 32 may be replaced with a combination of two known switching elements such as an MOSFET, an IGBT, and a JFET including a body diode.

The fourth power line 24 connects the variable voltage power supply 7 rather than the DC power supply 30 and the second switch unit 32 of the third power line 23 and the second power line 22. More specifically, the fourth power line 24 is connected to the third power line 23 between the DC power supply 30 and the third switch unit 33.

The fourth switch unit 34 includes a fourth diode 34a and a fourth switch 34b that are connected in parallel to the fourth power line 24. The fourth diode 34a allows the output current of the DC power supply 30 and allows a current in the direction opposite to the output current. The fourth switch 34b is switched on or off according to a gate drive signal GSW4 input from the switch controller 62. In FIG. 1, the fourth diode 34a and the fourth switch 34b constituting the fourth switch unit 34 are shown as separate circuit elements for ease of understanding, but the present invention is not limited thereto. The fourth switch unit 34 may be replaced with a known switching element as in the first switch unit 31.

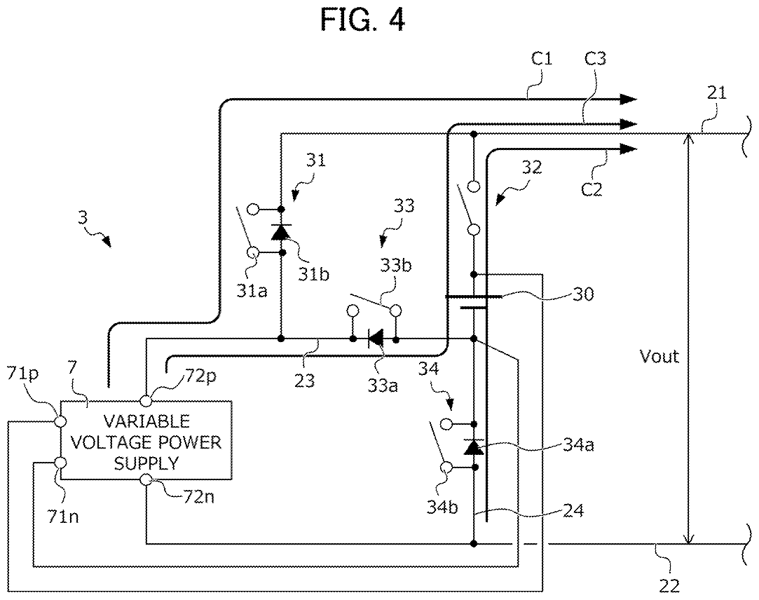

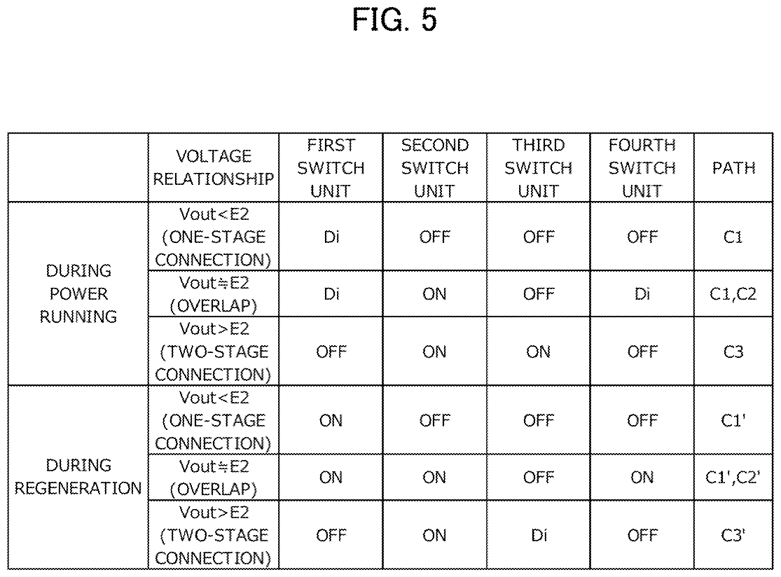

FIG. 4 is a diagram schematically showing current paths C1, C2, and C3 realized in the multi-stage voltage power supply 3 as described above. FIG. 5 is a table showing a relationship between states of the switch units 31 to 34 and the current paths C1, C2, and C3 realized in the multi-stage voltage power supply 3. In FIG. 5, “Di” indicates a state in which a current is flowing through the diodes included in the switch units 31, 33, and 34. In FIG. 5, paths C1′, C2′, and C3′ indicate paths reverse to the paths C1, C2, and C3, respectively.

When the system voltage Vout is changed within the range less than the output voltage E2 of the DC power supply 30 at the time of power running to supply the power to the load 4 in the power lines 21 and 22, the switch controller 62 turns off the second switch unit 32, the third switch unit 33, and the fourth switch unit 34 (see FIG. 5). Thus, the DC power supply 30 is disconnected from the load 4, and only the variable voltage power supply 7 is connected to the load 4 (one-stage connection). For this reason, the multi-stage voltage power supply 3 is formed with the current path C1 that passes through the variable voltage power supply 7 and the first switch unit 31 (see FIG. 4).

When the system voltage Vout is changed within the range larger than the output voltage E2 at the time of power running, the switch controller 62 turns on the second switch unit 32 and the third switch unit 33, and turns off the first switch unit 31 and the fourth switch unit 34 (see FIG. 5). Thus, the variable voltage power supply 7 and the DC power supply 30 are connected in series to the load 4 (two-stage connection). For this reason, the multi-stage voltage power supply 3 is formed with the current path C3 that passes through the variable voltage power supply 7, the third switch unit 33, the DC power supply 30, and the second switch unit 32 (see FIG. 4).

During power running, when the system voltage Vout is increased across the output voltage E2, that is, during switching from a one-stage connection to a two-stage connection, the switch controller 62 switches the second switch unit 32 from off to on, and then switches the third switch unit 33 from off to on. Further, during power running, when the system voltage Vout is lowered across the output voltage E2, that is, during switching from the two-stage connection to the one-stage connection, the switch controller 62 switches the third switch unit 33 from on to off, and then switches the second switch unit 32 from on to off. In other words, the switch controller 62 temporarily turns on the second switch unit 32 and turns off the third switch unit 33 during switching between the one-stage connection and the two-stage connection. Thus, it can realize a state where the variable voltage power supply 7 and the DC power supply 30 are connected in parallel to the load 4 (overlap state) only at the moment when the variable voltage E1 of the variable voltage power supply 7 becomes equal to the output voltage E2 of the DC power supply 30. In other words, at the moment when the variable voltage E1 becomes equal to the output voltage E2, the multi-stage voltage power supply 3 is formed with the current path C1 that passes through the variable voltage power supply 7 and the first switch unit 31 and the current path C2 that passes through the fourth switch unit 34, the DC power supply 30, and the second switch unit 32 (see FIG. 4).

The switch controller 62 turns on the first switch unit 31 and turns off the second switch unit 32, the third switch unit 33, and the fourth switch unit 34 when the system voltage Vout is changed in the range less than the output voltage E2 during regeneration in which the power in the load 4 is supplied to the power lines 21 and 22. Thus, the DC power supply 30 is disconnected from the load 4, and only the variable voltage power supply 7 is connected to the load 4 (one-stage connection). For this reason, the multi-stage voltage power supply 3 is formed with the path C1′ reverse to the path C1 that passes through the variable voltage power supply 7 and the first switch unit 31. Further, at this time, the power supply driver 61 operates the variable voltage power supply 7 to steps up the power in the pair of secondary-side input/output terminals 72p and 72n and to output the power from the pair of primary-side input/output terminals 71p and 71n, whereby the DC power supply 30 can be charged with the power supplied from the load 4.

The switch controller 62 turns on the second switch unit 32 and turns off the first switch unit 31 and the fourth switch unit 34 when the system voltage Vout is changed in the range larger than the output voltage E2 during regeneration. Thus, the variable voltage power supply 7 and the DC power supply 30 are connected in series to the load 4 (two-stage connection). For this reason, the multi-stage voltage power supply 3 is formed with the path C3′ reverse to the path C3 that passes through the second switch unit 32, the DC power supply 30, the third switch unit 33, and the variable voltage power supply 7. Further, at this time, the power supply driver 61 operates the variable voltage power supply 7 to steps up the power in the pair of secondary-side input/output terminals 72p and 72n and to output the power from the pair of primary-side input/output terminals 71p and 71n, whereby the DC power supply 30 can be charged with the power supplied from the load 4.

During regeneration, when the system voltage Vout is increased across the output voltage E2, that is, during switching from a one-stage connection to a two-stage connection, the switch controller 62 switches the second switch unit 32 and the fourth switch unit 34 from off to on, and then switches the first switch unit 31 and the fourth switch unit 34 from on to off. Further, during regeneration, when the system voltage Vout is lowered across the output voltage E2, that is, during switching from the two-stage connection to the one-stage connection, the switch controller 62 switches the first switch unit 31 and the fourth switch unit 34 from off to on, and then switches the second switch unit 32 and the fourth switch unit 34 from on to off. In other words, the switch controller 62 temporarily turns on the first switch unit 31, the second switch unit 32, and the fourth switch unit 34 and turns off the third switch unit 33 during switching between the one-stage connection and the two-stage connection. Thus, it can realize the above-described overlap state only at the moment when the variable voltage E1 of the variable voltage power supply 7 becomes equal to the output voltage E2 of the DC power supply 30. In other words, at the moment when the variable voltage E1 becomes equal to the output voltage E2, the multi-stage voltage power supply 3 is formed with the current paths C1′ and C2′ reverse to the paths C1 and C2.

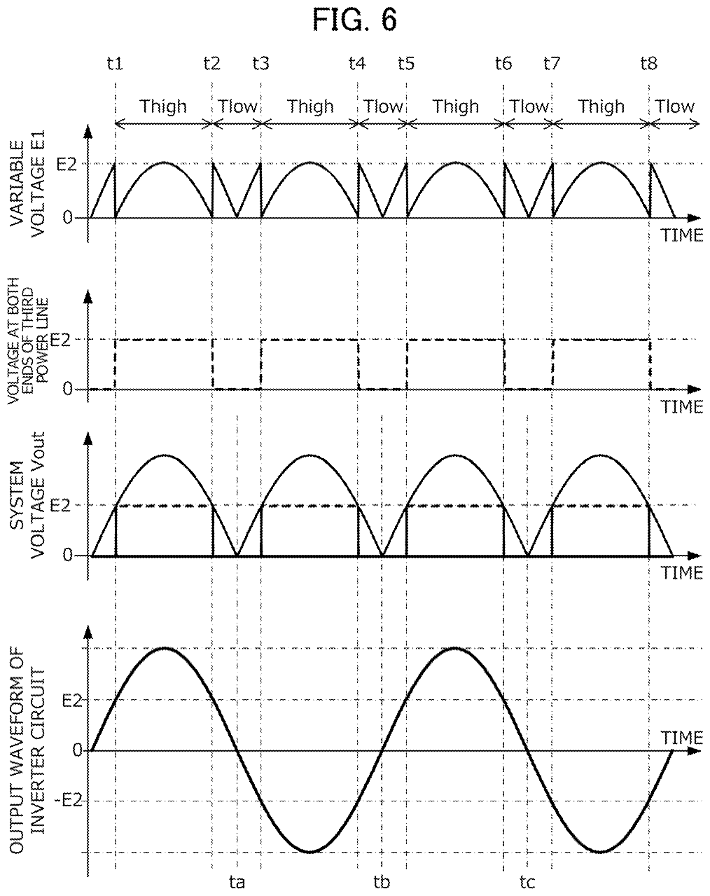

Next, a description will be given with respect to a procedure for generating sinusoidal AC power as shown at the lowermost stage in FIG. 6 in the power supply system 1 as described above. FIG. 6 is an example of a time chart showing a change in voltage of each portion of the power supply system 1 during power running of the load 4. The uppermost stage in FIG. 6 indicates the variable voltage E1 of the variable voltage power supply 7, a second stage from the top indicates the voltage between both ends of the third power line 23, a second stage from the bottom indicates the system voltage Vout between the first power line 21 and the second power line 22, and the lowermost stage indicates the output waveform of the inverter circuit 5.

During a period in which the system voltage Vout is changed in the range less than the output voltage E2 of the DC power supply 30 (see “Tlow” in FIG. 6), the switch controller 62 turns off the second switch unit 32, the third switch unit 33, and the fourth switch unit 34, whereby the DC power supply 30 is disconnected from the load 4 and only the variable voltage power supply 7 is connected to the load 4. For this reason, as shown in the second stage from the top in FIG. 6, the voltage between both ends of the third power line 23 becomes 0 during the period Tlow. Further, during the period Tlow, the power supply driver 61 operates the variable voltage power supply 7 to change the variable voltage E1 from 0 to the output voltage E2 of the DC power supply 30 as shown in the uppermost stage in FIG. 6. Therefore, as shown in the second stage from the bottom in FIG. 6, the system voltage Vout in the period Tlow is equal to the variable voltage E1 of the variable voltage power supply 7.

Further, during a period in which the system voltage Vout is changed in the range larger than the output voltage E2 of the DC power supply 30 (see “Thigh” in FIG. 6), the switch controller 62 turns on the second switch unit 32 and the third switch unit 33 and turns off the first switch unit 31 and the fourth switch unit 34, whereby the variable voltage power supply 7 and the DC power supply 30 are connected in series to the load 4. For this reason, as shown in the second stage from the top in FIG. 6, the voltage between both ends of the third power line 23 becomes equal to the output voltage E2 of the DC power supply 30 during the period Thigh. Further, during the period Thigh, the power supply driver 61 operates the variable voltage power supply 7 to change the variable voltage E1 from 0 to a predetermined maximum voltage as shown in the uppermost stage in FIG. 6. Therefore, as shown in the second stage from the bottom in FIG. 6, the system voltage Vout in the period Thigh is the sum of the variable voltage E1 and the output voltage E2.

Further, at times t1, t3, t5, and t7 during a transition from the period Tlow to the period Thigh and at times t2, t4, t6, and t8 during a transition from the period Thigh to the period Tlow, the switch controller 62 temporarily turns on the second switch unit 32 and turns off the third switch unit 33. In addition, the power supply driver 61 sharply lowers the variable voltage E1 from the output voltage E2 to 0 at times t1, t3, t5, and t7, and sharply raises the variable voltage E1 from 0 to the output voltage E2 at times t2, t4, t6, and t8. For this reason, at times t1 to t8, the variable voltage E1 and the output voltage E2 become equal to each other, and the overlap state as described above is realized, whereby the system voltage Vout is not significantly disturbed.

According to the power supply system 1 as described above, as shown in the second stage from the bottom in FIG. 6, the waveform of the system voltage Vout can be made into a full-wave rectified wave without using the inverter circuit 5. Therefore, the inverter controller 8 operates the switching circuit 5 only at times ta, tb, and tc when the system voltage Vout becomes 0, and thus the sinusoidal AC power can be supplied to the load 4 as shown in the lowermost stage in FIG. 6.

According to the power supply system 1 of the present embodiment, the following effects are obtained.

(1) The power supply system 1 includes the variable voltage power supply 7, the power lines 21 and 22 that connect the pair of secondary-side input/output terminals 72p and 72n of the variable voltage power supply 7 and the load 4, the first switch unit 31 provided on the first power line 21, the third power line 23 that is connected to the first power line 21 so as to bypass the first switch unit 31, and the DC power supply 30 and the second switch unit 32 that are connected in series to the third power line 23. According to the present embodiment, when the system voltage Vout, which is the voltage between the power lines 21 and 22, is changed in a range less than the output voltage E2 of the DC power supply 30 (when a low voltage is applied), the second switch unit 32 is turned off, whereby the system voltage Vout can be changed only by the output of the variable voltage power supply 7. Further, according to the present embodiment, when the system voltage Vout is changed in a range more than the output voltage E2 (when a high voltage is applied), the first switch unit 31 is turned off, and the variable voltage E1 of the variable voltage power supply 7 is superimposed on the DC voltage E2 of the DC power supply 30, whereby the system voltage Vout can be changed in the range larger than the output voltage E2. Therefore, according to the present embodiment, since it is not necessary to operate the switch in order to change the system voltage Vout both when the low voltage is applied and when the high voltage is applied, it is not necessary to increase the number of switches in a case of making the voltage multiple stages. For this reason, it is possible to reduce the number of switches as compared with the case of making the voltage multiple stages by the multi-stage DC chopper circuit as disclosed in Patent Document 1, for example, and thus it is possible to reduce switching loss and steady loss to that extent.

Further, according to the present embodiment, as described above, it is not necessary to operate the switch to change the voltage during the high-voltage application, and thus it is not necessary to consider a surge voltage during the high-voltage application in a case of designing the withstand voltage of the switch of the inverter circuit 5 included in the power supply system. Therefore, according to the present embodiment, it is possible to lower the withstand voltage of the switch included in the multi-stage voltage power supply 3 as compared with the case of making the voltage multiple stages by the multi-stage DC chopper circuit as disclosed in Patent Document 1, for example, and thus it is possible to reduce steady loss in the switch and to further reduce costs of the switch.

Further, according to the present embodiment, as described above, it is not necessary to operate the inverter circuit 5 to change the voltage during the high-voltage application, and thus a high frequency component of the voltage applied to the load 4 can be reduced, whereby it is also possible to reduce iron loss.

(2) The power supply system 1 includes the fourth power line 24 that connects the variable voltage power supply 7 rather than the DC power supply 30 and the second switch unit 32 of the third power line 23 and the second power line 22, the third switch unit 33 provided closer to the variable voltage power supply 7 of the third power line 23 than the connection point with the fourth power line 24, and the fourth diode 34a provided on the fourth power line 24. According to the present embodiment, when the fourth power line 24 and the fourth diode 34a are provided at these positions, the variable voltage power supply 7 and the DC power supply 30 can be connected in parallel to the load 4 (hereinafter, also referred to as a “overlap stage”) only at the moment when the variable voltage E1 of the variable voltage power supply 7 becomes equal to the output voltage E2 of the DC power supply 30 when the system voltage Vout is changed across the output voltage E2 of the DC power supply 30, that is, when the power circuit formed by the multi-stage voltage power supply 3 is switched between the one-stage connection in which only the variable voltage power supply 7 is connected to the load 4 and the two-stage connection in which the variable voltage power supply 7 and the DC power supply 30 are connected in series to the load 4, whereby it is possible to prevent a large change in the system voltage Vout at the time of switching between the one-stage connection and the two-stage connection.

(3) In the power supply system 1, the first switch unit 31 is provided in which the first diode 31a and the first switch 31b are connected in parallel to the first power line 21, the third switch unit 33 is provided in which the third diode 33a and the third switch 33b are connected in parallel to the third power line 23, and the fourth switch unit 34 is provided in which the fourth diode 34a and the fourth switch 34b are connected in parallel to the fourth power line 24. According to the present embodiment, it is possible to prevent the current from flowing in an unintended direction during power running and during regeneration of the power supply system 1.

(4) The power supply system 1 includes the power supply driver 61 that changes the variable voltage E1 between the pair of secondary-side input/output terminals 72p and 72n from 0 to a predetermined maximum voltage by operating the variable voltage power supply 7. According to the present embodiment, it is possible to shape the waveform of the variable voltage E1 of the power output from the variable voltage power supply 7 by the power supply driver 61 into a preferred waveform, and thus it is possible to supply the AC power having the preferred waveform to the load without operating the multi-stage voltage power supply 3 and the switch included in the inverter circuit 5 connected between the multi-stage voltage power supply 3 and the load 4 while the variable voltage E1 is applied to the load 4.

(5) According to the power supply system 1, the switch controller 62 controls the switch units 31 to 34 based on the system voltage Vout, and thus it is possible to switch the power circuit formed by the multi-stage voltage power supply 3 between the one-stage connection and the two-stage connection at an appropriate timing such that the system voltage Vout is not disturbed.

(6) In the power supply system 1, the switch controller 62 turns off the second switch unit 32, the third switch unit 33, and the fourth switch unit 34 when changing the system voltage Vout in the range less than the output voltage E2 during power running, whereby only the variable voltage power supply 7 is connected to the load 4 (that is, one-stage connection), and the power output from the variable voltage power supply 7 can be supplied to the load 4. Further, when the system voltage Vout is changed in the range larger than the output voltage E2 during power running, the switch controller 62 turns on the second switch unit 32 and the third switch unit 33 and turns off the first switch unit 31 and the fourth switch unit 34, whereby the variable voltage power supply 7 and the DC power supply 30 are connected in series to the load (that is, two-stage connection), and the power output from these power supplies 7 and 30 can be supplied to the load 4.

(7) In the power supply system 1, the switch controller 62 switches the second switch unit 32 from off to on, and then switches the third switch unit 33 from off to on when raising the system voltage Vout across the output voltage E2 during power running, and the switch controller 62 switches the third switch unit 33 from on to off, and then switches the second switch unit 32 from on to off when lowering the system voltage Vout across the output voltage E2 during power running. Thus, during switching between the one-stage connection and the two-stage connection, an overlap state can be realized instantaneously, and thus a large change in system voltage Vout can be prevented during the switching between the one-stage connection and the two-stage connection.

(8) In the power supply system 1, the switch controller 62 turns on the first switch unit 31 and turns off the second switch unit 32, the third switch unit 33, and the fourth switch unit 34 when changing the system voltage Vout in the range less than the output voltage E2 during regeneration, whereby only the variable voltage power supply 7 is connected to the load 4 (that is, one-stage connection), and regenerative power can be supplied to the variable voltage power supply 7. Further, the switch controller 62 turns on the second switch unit 32 and turns off the first switch unit 31 and the fourth switch unit 34 when changing the system voltage Vout in the range larger than the output voltage E2 during regeneration, whereby the variable voltage power supply 7 and the DC power supply 30 are connected in series to the load 4 (that is, two-stage connection), and the regenerative power can be divided to be supplied to the DC power supply 30 and the variable voltage power supply 7.

(9) In the power supply system 1, the switch controller 62 switches the second switch unit 32 and the fourth switch unit 34 from off to on and then switches the first switch unit 31 and the fourth switch unit 34 from on to off when raising the system voltage Vout across the output voltage E2 during regeneration, and the switch controller 62 switches the first switch unit 31 and the fourth switch unit 34 from off to on and then switches the second switch unit 32 and the fourth switch unit 34 from on to off when lowering the system voltage Vout across the output voltage E2 during regeneration. Thus, during switching between the one-stage connection and the two-stage connection, an overlap state can be realized instantaneously, and thus a large change in system voltage Vout can be prevented during the switching between the one-stage connection and the two-stage connection.

### Second Embodiment

Next, a power supply system according to a second embodiment of the present invention will be described with reference to the drawings. Further, in the following description of the power supply system according to the present embodiment, the same components as those of the power supply system 1 according to the first embodiment are denoted by the same reference numerals, and details thereof will not be described. The power supply system according to the present embodiment differs in a circuit configuration of the variable voltage power supply from that of the first embodiment.

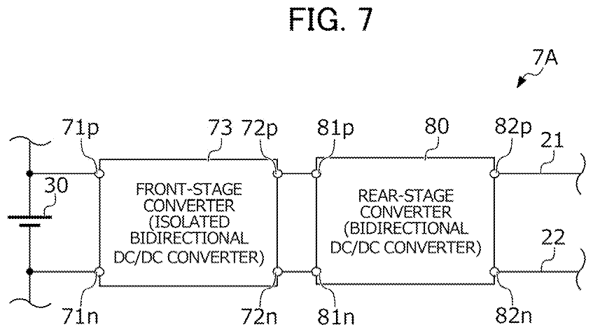

FIG. 7 is a diagram showing a circuit configuration of a variable voltage power supply 7A of the power supply system according to the present embodiment. The variable voltage power supply 7A includes a front-stage converter 73 and a rear-stage converter 80 which are combined in series in order from the DC power supply 30 to the power lines 21 and 22.

The front-stage converter 73 is an isolated bidirectional DC/DC converter including an insulation transformer (not shown), a primary-side circuit (not shown) that connects a primary side of the insulation transformer and the pair of primary-side input/output terminals 71p and 71n, and a secondary-side circuit (not shown) that connects a secondary side of the insulation transformer and a pair of primary-side input/output terminals 81p and 81n of the rear-stage converter 80. Further, since the front-stage converter 73 has the same configuration as the variable voltage power supply 7 described with reference to FIG. 2, details thereof will not be described. As in the variable voltage power supply 7 according to the first embodiment, the pair of primary-side input/output terminals 71p and 71n of the front-stage converter 73 is connected to both the positive and negative electrodes of the DC power supply 30. Further, as in the variable voltage power supply 7 according to the first embodiment, both pair of secondary-side input/output terminals 72p and 72n of the isolated bidirectional DC/DC converter 73 are connected to the first power line 21 and the second power line 22, respectively, through the rear-stage converter 80.

The rear-stage converter 80 is a bidirectional DC/DC converter including a pair of primary-side input/output terminals 81p and 81n connected to the pair of secondary-side input/output terminals 72p and 72n of the front-stage converter 73 and a pair of secondary-side input/output terminals 82p and 82n connected to the power lines 21 and 22, respectively, and capable of stepping up or down the DC power between the pair of primary-side input/output terminals 81p and 81n and the pair of secondary-side input/output terminals 82p and 82n to bidirectionally input and output the DC power.

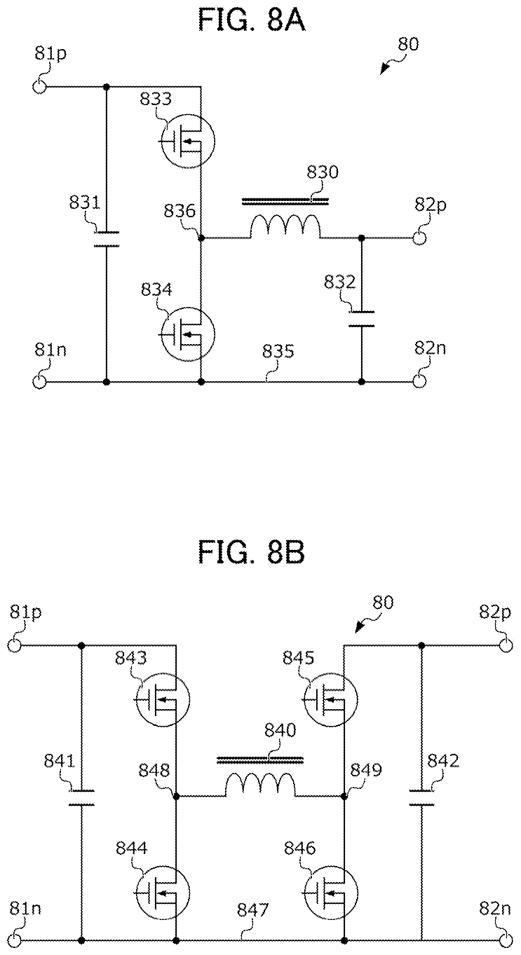

FIG. 8A is a diagram showing a first example of the rear-stage converter 80. The rear-stage converter 80 shown in FIG. 8A is a step-up/down chopper circuit configured by a combination of; a step-down chopper circuit that steps down the DC power input to the pair of primary-side input/output terminals 81p and 81n and outputs it to the pair of secondary-side input/output terminals 82p and 82n; and a step-up chopper circuit that steps up the DC power input to the pair of secondary-side input/output terminals 82p and 82n and outputs it to the pair of primary-side input/output terminals 81p and 81n.

The rear-stage converter 80 shown in FIG. 8A includes a reactor 830, a primary-side capacitor 831, a secondary-side capacitor 832, a first switching element 833, a second switching element 834, and a negative bus 835.

The negative bus 835 is a wiring for connecting the primary-side input/output terminal 81n and the secondary-side input/output terminal 82n. The reactor 830 has one end side connected to the secondary-side input/output terminal 82p and the other end side connected to a connection node 836 between the first switching element 833 and the second switching element 834. The primary-side capacitor 831 has one end side connected to the primary-side input/output terminal 81p and the other end side connected to the negative bus 835. The secondary-side capacitor 832 has one end side connected to the secondary-side input/output terminal 82p and the other end side connected to the negative bus 835. For the switching elements 833 and 834, for example, an N-channel MOSFET is used as in the switching element 711 shown in FIG. 2. A drain of the first switching element 833 is connected to the primary-side input/output terminal 81p, and a source of the first switching element 833 is connected to the reactor 830. Further, a drain of the second switching element 834 is connected to the reactor 830, and a source of the second switching element 834 is connected to the negative bus 835.

According to the rear-stage converter 80 shown in FIG. 8A, switching of the switching elements 833 and 834 is controlled by a drive circuit (not shown), whereby the DC power in the pair of primary-side input/output terminals 81p and 81n can be stepped down to be output from the pair of secondary-side input/output terminals 82p and 82n, and the DC power in the pair of secondary-side input/output terminals 82p and 82n can be stepped up to be output from the pair of primary-side input/output terminals 81p and 81n.

FIG. 8B is a diagram showing a second example of the rear-stage converter 80. The rear-stage converter 80 shown in FIG. 8B is a buck-boost converter configured by a combination of: a step-up/down chopper circuit that steps up and down the DC power input to the pair of primary-side input/output terminals 81p and 81n and outputs it to the pair of secondary-side input/output terminals 82p and 82n; and a step-up/down chopper circuit that steps up and down the DC power input to the pair of secondary-side input/output terminals 82p and 82n and outputs it to the pair of primary-side input/output terminals 81p and 81n.

The rear-stage converter 80 shown in FIG. 8B includes a reactor 840, a primary-side capacitor 841, a secondary-side capacitor 842, a first switching element 843, a second switching element 844, a third switching element 845, a fourth switching element 846, and a negative bus 847.

The negative bus 847 is a wiring for connecting the primary-side input/output terminal 81n and the secondary-side input/output terminal 82n. The reactor 840 has one end side connected to a connection node 848 between the first switching element 843 and the second switching element 844 and the other end side connected to a connection node 849 between the third switching element 845 and the fourth switching element 846. The primary-side capacitor 841 has one end side connected to the primary-side input/output terminal 81p and the other end side connected to the negative bus 847. The secondary-side capacitor 842 has one end side connected to the secondary-side input/output terminal 82p and the other end side connected to the negative bus 787. For the switching elements 843 to 846, for example, an N-channel MOSFET is used as in the switching element 711 shown in FIG. 2. A drain of the first switching element 843 is connected to the primary-side input/output terminal 81p, and a source of the first switching element 843 is connected to the reactor 840. A drain of the second switching element 844 is connected to the reactor 840, and a source of the second switching element 844 is connected to the negative bus 847. A drain of the third switching element 845 is connected to the secondary-side input/output terminal 82p, and a source of the third switching element 845 is connected to the reactor 840. Further, a drain of the fourth switching element 846 is connected to the reactor. 840, and a source of the fourth switching element 846 is connected to the negative bus 847.

According to the rear-stage converter 80 shown in FIG. 8B, switching of the switching elements 843 to 846 is controlled by a drive circuit (not shown), whereby the DC power in the pair of primary-side input/output terminals 81p and 81n can be stepped up and down to be output from the pair of secondary-side input/output terminals 82p and 82n, and the DC power in the pair of secondary-side input/output terminals 82p and 82n can be stepped up and down to be output from the pair of primary-side input/output terminals 81p and 81n.

According to the power supply system of the present embodiment, the following effects can be obtained in addition to the effects of (1) to (9) described above.

(10) In the first embodiment described above, the case has been described in which the isolated bidirectional DC/DC converter shown in FIG. 2 is used as the variable voltage power supply 7 and the pair of secondary-side input/output terminals 72p and 72n are directly connected to the positive electrode power line 21. However, in this case, the control range is limited during regeneration in which the DC power input to the pair of secondary-side input/output terminals 72p and 72n is transformed and is output from the pair of primary-side input/output terminals 71p and 71n. On the other hand, in the present embodiment, the front-stage converter 73 serving as an isolated bidirectional DC/DC converter and the rear-stage converter 80 serving as a bidirectional DC/DC converter are combined to be used as the variable voltage power supply 7A. In other words, in the present embodiment, the front-stage converter 73 is connected to the power lines 21 and 22 through the rear-stage converter 80. Therefore, according to the present embodiment, since the rear-stage converter 80 can be driven and the DC power on the power lines 21 and 22 can be stepped up or stepped down as needed and supplied to the front-stage converter 73 during regeneration, it is possible to make the control range during regeneration equal to the control range during power running.

### Third Embodiment

Next, a power supply system according to a third embodiment of the present invention will be described with reference to the drawings. Further, in the following description of the power supply system according to the present embodiment, the same components as those of the power supply system 1 according to the first embodiment are denoted by the same reference numerals, and details thereof will not be described.

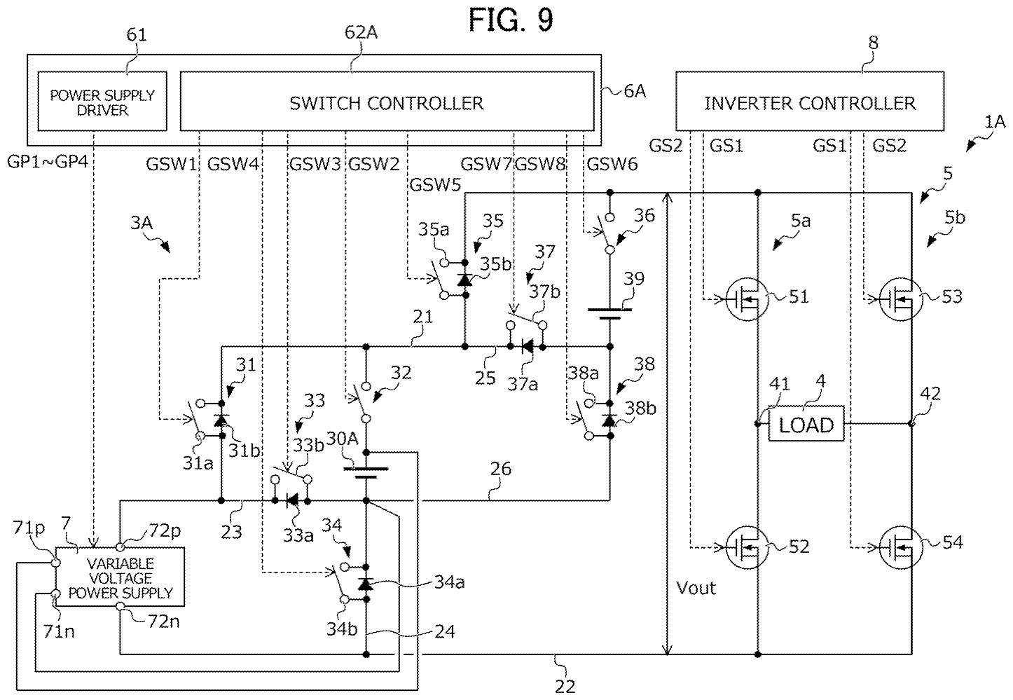

FIG. 9 is a diagram showing a circuit configuration of a power supply system 1A according to the present embodiment. The power supply system 1A according to the present embodiment differs from that of the first embodiment in terms of configurations of a multi-stage voltage power supply 3A and a multi-stage power supply controller 6A.

The multi-stage voltage power supply 3A includes a variable voltage power supply 7, a first power line 21, a second power line 22, a third power line 23, a fourth power line 24, a fifth power line 25, a sixth power line 26, a first switch unit 31, a second switch unit 32, a third switch unit 33, a fourth switch unit 34, a fifth switch unit 35, a sixth switch unit 36, a seventh switch unit 37, an eighth switch unit 38, a first DC power supply 30A, and a second DC power supply 39. The multi-stage voltage power supply 3A is a four-level DC voltage power supply that can output DC voltages of four stages of 0 [V], E1 [V], E1+E2 [V] (hereinafter, an output voltage of the DC power supply 30A being referred to as E2), and E1+E2+E3 [V] (hereinafter, an output voltage of the second DC power supply 39 being referred to as E3), according to a circuit configuration to be described below.

The multi-stage voltage power supply controller 6A includes a power supply driver 61 that changes the variable voltage E1 from 0 to a predetermined maximum voltage by operating the variable voltage power supply 7, and a switch controller 62A that controls switch units 31 to 38 based on a system voltage Vout, which is a voltage between the power lines 21 and 22.

The first DC power supply 30A is connected to the third power line 23 with a positive electrode on the load 4 and a negative electrode on the variable voltage power supply 7. The first DC power supply 30A outputs the DC power of the output voltage E2 to the third power line 23. In the present embodiment, a case will be described in which the first DC power supply 30A is a secondary battery capable of performing both of discharging during which chemical energy is converted into electric energy and charging during which electric energy is converted into chemical energy, but the present invention is not limited thereto. For example, as the first DC power supply 30A, a fuel cell may be used that generates electricity when an oxygen-containing oxidant gas and a hydrogen gas are supplied.

The second DC power supply 39 is connected to the fifth power line 25 with a positive electrode on the load 4 and a negative electrode on the variable voltage power supply 7. The second DC power supply 39 outputs the DC power of the output voltage E3 to the fifth power line 25. In the present embodiment, a case will be described in which the second DC power supply 39 is a secondary battery capable of performing both of discharging during which chemical energy is converted into electric energy and charging during which electric energy is converted into chemical energy, but the present invention is not limited thereto. For example, as the second DC power supply 39, a fuel cell may be used that generates electricity when an oxygen-containing oxidant gas and a hydrogen gas are supplied.

A pair of primary-side input/output terminals 71p and 71n of the variable voltage power supply 7 are connected to both the positive and negative electrodes of the first DC power supply 30A.

The fifth switch unit 35 is provided closer to the load 4 than the connection point of the first switch unit 31 of the first power line 21 and the third power line 23. The fifth switch unit 35 includes a fifth diode 35a and a fifth switch 35b that are connected in parallel to the first power line 21. The fifth diode 35a allows the output current of the variable voltage power supply 7 and cuts off a current reverse to the output current. The fifth switch 35b is switched on or off according to a gate drive signal GSW5 input from the switch controller 62A. Further, in FIG. 9, the fifth diode 35a and the fifth switch 35b constituting the fifth switch unit 35 are shown as separate circuit elements for easy understanding, but the present invention is not limited thereto. The fifth switch unit 35 may be replaced with a known switching element as in the first switch unit 31.

The fifth power line 25 is connected to both ends of the fifth switch unit 35. More specifically, one end side of the fifth power line 25 is connected to the first power line 21 between the fifth switch unit 35 and the connection point of the third power line 23, and the other end side of the fifth power line 25 is connected to the first power line 21 closer to the load 4 than the fifth switch unit 35.

The seventh switch unit 37, the second DC power supply 39, and the sixth switch unit 36 are connected in series to the fifth power line 25 in order from the variable voltage power supply 7 to the load 4. More specifically, the seventh switch unit 37 is connected to the fifth power line 25 closer to the negative electrode of the second DC power supply 39, and the sixth switch unit 36 is connected to the fifth power line 25 closer to the positive electrode of the second DC power supply 39.

The seventh switch unit 37 includes a seventh diode 37a and a seventh switch 37b that are connected in parallel to the fifth power line 25. The seventh diode 37a cuts off the output current of the second DC power supply 39 and allows a current reverse to the output current. The seventh switch 37b is switched on or off according to a gate drive signal GSW7 input from the switch controller 62A. Further, in FIG. 9, the seventh diode 37a and the seventh switch 37b constituting the seventh switch unit 37 are shown as separate circuit elements for easy understanding, but the present invention is not limited thereto. The seventh switch unit 37 may be replaced with a known switching element as in the first switch unit 31.

The sixth switch unit 36 is switched on or off according to a gate drive signal GSW6 input from the switch controller 62A. The sixth switch unit 36 may be replaced with a combination of two known switching elements such as an MOSFET, an IGBT, and a JFET including a body diode.

The sixth power line 26 connects the fifth power line 25 closer to the variable voltage power supply 7 than the second DC power supply 39 and the sixth switch unit 36 and the third power line 23 between the first DC power supply 30A and the third switch unit 33.

The eighth switch unit 38 is provided on the sixth power line 26. The eighth switch unit 38 includes an eighth diode 38a and an eighth switch 38b that are connected in parallel to the sixth power line 26. The eighth diode 38a allows the output current of the second DC power supply 39 and cuts off a current reverse to the output current. The eighth switch 38b is switched on or off according to a gate drive signal GSW8 input from the switch controller 62A. Further, in FIG. 9, the eighth diode 38a and the eighth switch 38b constituting the eighth switch unit 38 are shown as separate circuit elements for easy understanding, but the present invention is not limited thereto. The eighth switch unit 38 may be replaced with a known switching element as in the first switch unit 31.

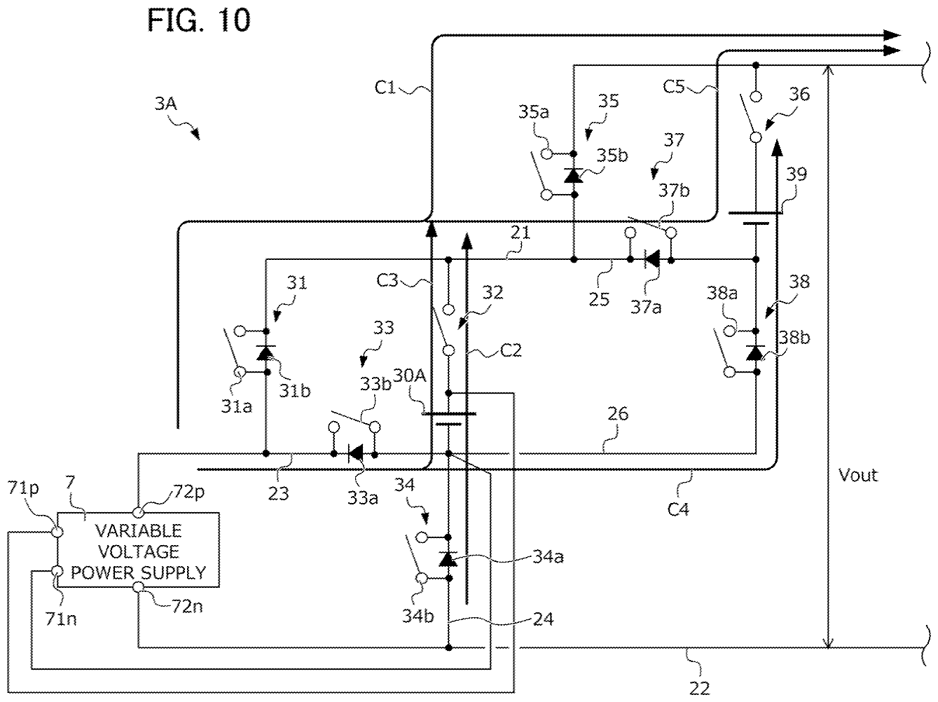

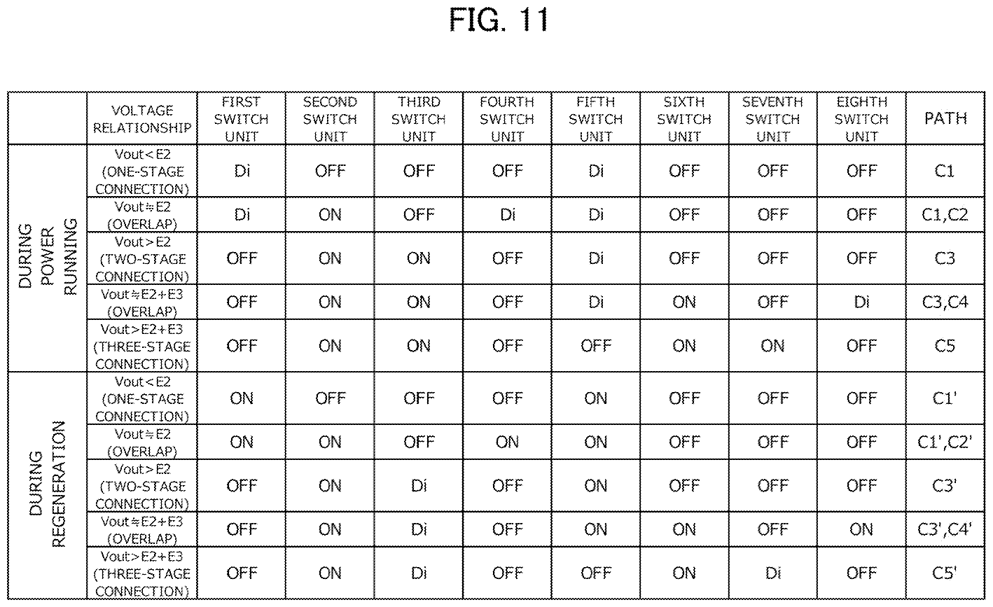

FIG. 10 is a diagram schematically showing current paths C1, C2, C3, C4, and C5 realized in the multi-stage voltage power supply 3A as described above. FIG. 11 is a table showing a relationship between states of the switch units 31 to 38 and the current paths C1, C2, C3, C4, and C5 realized in the multi-stage voltage power supply 3A. In FIG. 11, “Di” indicates a state in which a current is flowing through the diodes included in the switch units 31, 33, 34, 35, and 37. In FIG. 11, paths C1′, C2′, C3′, C4′, and C5′ indicate paths reverse to the paths C1, C2, C3, C4, and C5, respectively.

When the system voltage Vout is changed within a range less than the output voltage E2 of the first DC power supply 31A at the time of power running, the switch controller 62A turns off the second switch unit 32, the third switch unit 33, the fourth switch unit 34, the sixth switch unit 36, the seventh switch unit 37, and the eighth switch unit 38 (see FIG. 11). Thus, the first DC power supply 30A and the second DC power supply 39 are disconnected from the load 4, and only the variable voltage power supply 7 is connected to the load 4 (one-stage connection). For this reason, the multi-stage voltage power supply 3A is formed with the current path C1 that passes through the variable voltage power supply 7, the first switch unit 31, and the fifth switch unit 35 (see FIG. 10).

When the system voltage Vout is changed within a range larger than the output voltage E2 and less than the output voltage E2+E3 at the time of power running, the switch controller 62A turns on the second switch unit 32 and the third switch unit 33 and turns off the first switch unit 31, the fourth switch unit 34, the sixth switch unit 36, the seventh switch unit 37, and the eighth switch unit 38 (see FIG. 11). Thus, the second DC power supply 39 is disconnected from the load 4, and the variable voltage power supply 7 and the first DC power supply 30A are connected in series to the load 4 (two-stage connection). For this reason, the multi-stage voltage power supply 3A is formed with the current path C3 that passes through the variable voltage power supply 7, the third switch unit 33, the first DC power supply 30A, the second switch unit 32, and the fifth switch unit 35 (see FIG. 10).

When the system voltage Vout is changed within a range larger than the output voltage E2+E3 at the time of power running, the switch controller 62A turns on the second switch unit 32, the third switch unit 33, the sixth switch unit 36, and the seventh switch unit 37 and turns off the first switch unit 31, the fourth switch unit 34, the fifth switch unit 35, and the eighth switch unit 38 (see FIG. 11). Thus, the variable voltage power supply 7, the first DC power supply 30A, and the second DC power supply 39 are connected in series to the load 4 (three-stage connection). For this reason, the multi-stage voltage power supply 3A is formed with the current path C5 that passes through the variable voltage power supply 7, the third switch unit 33, the first DC power supply 30A, the second switch unit 32, the seventh switch unit 37, the second DC power supply 39, and the sixth switch unit 36 (see FIG. 10).

During power running, when the system voltage Vout is increased across the output voltage E2, that is, during switching from the one-stage connection to the two-stage connection, the switch controller 62A switches the second switch unit 32 from off to on, and then switches the third switch unit 33 from off to on. Further, during power running, when the system voltage Vout is lowered across the output voltage E2, that is, during switching from the two-stage connection to the one-stage connection, the switch controller 62A switches the third switch unit 33 from on to off, and then switches the second switch unit 32 from on to off. In other words, the switch controller 62A temporarily turns on the second switch unit 32 and turns off the third switch unit 33 during switching between the one-stage connection and the two-stage connection. Thus, it can realize a state where the variable voltage power supply 7 and the first DC power supply 30A are connected in parallel to the load 4 (overlap state) only at the moment when the variable voltage E1 of the variable voltage power supply 7 becomes equal to the output voltage E2 of the first DC power supply 30A. In other words, at the moment when the variable voltage E1 becomes equal to the output voltage E2, the multi-stage voltage power supply 3A is formed with the current path C1 and the current path C2 that passes through the fourth switch unit 34, the first DC power supply 30A, and the second switch unit 32 (see FIG. 10).

During power running, when the system voltage Vout is increased across the output voltage E2+E3, that is, during switching from the two-stage connection to the three-stage connection, the switch controller 62A switches the sixth switch unit 36 from off to on, and then switches the seventh switch unit 37 from off to on. Further, during power running, when the system voltage Vout is lowered across the output voltage E2+E3, that is, during switching from the three-stage connection to the two-stage connection, the switch controller 62A switches the seventh switch unit 37 from on to off, and then switches the sixth switch unit 36 from on to off. In other words, the switch controller 62A temporarily turns on the sixth switch unit 36 and turns off the seventh switch unit 37 during switching between the two-stage connection and the three-stage connection. Thus, it can realize a state where the first DC power supply 30A and the second DC power supply 39 are connected in parallel to the load 4 (overlap state) only at the moment when the variable voltage E1 of the variable voltage power supply 7 becomes equal to the output voltage E3 of the second DC power supply 39. In other words, at the moment when the variable voltage E1 becomes equal to the output voltage E3, the multi-stage voltage power supply 3A is formed with the current path C3 and the current path C4 that passes through the eighth switch unit 38, the second DC power supply 39, and the seventh switch unit 37 (see FIG. 10).

The switch controller 62A turns on the first switch unit 31 and the fifth switch unit 35 and turns off the second switch unit 32, the third switch unit 33, the fourth switch unit 34, the sixth switch unit 36, the seventh switch unit 37, and the eighth switch unit 38 when the system voltage Vout is changed in the range less than the output voltage E2 during regeneration. Thus, the first DC power supply 30A and the second DC power supply 39 are disconnected from the load 4, and only the variable voltage power supply 7 is connected to the load 4 (one-stage connection). For this reason, the multi-stage voltage power supply 3A is formed with the path C1′ reverse to the path C1. Further, at this time, the power supply driver 61 operates the variable voltage power supply 7 to steps up the power in the pair of secondary-side input/output terminals 72p and 72n and to output the power from the pair of primary-side input/output terminals 71p and 71n, whereby the first DC power supply 30A can be charged with the power supplied from the load 4.

The switch controller 62A turns on the second switch unit 32 and the fifth switch unit 35 and turns off the first switch unit 31, the third switch unit 33, the sixth switch unit 36, the seventh switch unit 37, and the eighth switch unit 38 when the system voltage Vout is changed in the range larger than the output voltage E2 and less than the output voltage E2+E3 during regeneration. Thus, the variable voltage power supply 7 and the first DC power supply 30A are connected in series to the load 4 (two-stage connection). For this reason, the multi-stage voltage power supply 3 is formed with the path C3′ reverse to the path C3. Further, at this time, the power supply driver 61 operates the variable voltage power supply 7 to steps up the power in the pair of secondary-side input/output terminals 72p and 72n and to output the power from the pair of primary-side input/output terminals 71p and 71n, whereby the first DC power supply 30A can be charged with the power supplied from the load 4.

When the system voltage Vout is changed within a range larger than the output voltage E2+E3 during regeneration, the switch controller 62A turns on the second switch unit 32 and the sixth switch unit 36 and turns off the first switch unit 31, the third switch unit 33, the fourth switch unit 34, the fifth switch unit 35, and the eighth switch unit 38. Thus, the variable voltage power supply 7, the first DC power supply 30A, and the second DC power supply 39 are connected in series to the load 4 (three-stage connection). For this reason, the multi-stage voltage power supply 3 is formed with the path C5′ reverse to the path C5. Further, at this time, the power supply driver 61 operates the variable voltage power supply 7 to steps up the power in the pair of secondary-side input/output terminals 72p and 72n and to output the power from the pair of primary-side input/output terminals 71p and 71n, whereby the first DC power supply 30A can be charged with the power supplied from the load 4.

During regeneration, when the system voltage Vout is increased across the output voltage E2, that is, during switching from the one-stage connection to the two-stage connection, the switch controller 62A switches the second switch unit 32 and the fourth switch unit 34 from off to on, and then switches the first switch unit 31 and the fourth switch unit 34 from on to off. Further, during regeneration, when the system voltage Vout is lowered across the output voltage E2, that is, during switching from the two-stage connection to the one-stage connection, the switch controller 62A switches the first switch unit 31 and the fourth switch unit 34 from off to on, and then switches the second switch unit 32 and the fourth switch unit 34 from on to off. In other words, the switch controller 62A turns off the third switch unit 33 and temporarily turns on the first switch unit 31, the second switch unit 32, and the fourth switch unit 34 during switching between the one-stage connection and the two-stage connection. Thus, it can realize the above-described overlap state only at the moment when the variable voltage E1 of the variable voltage power supply 7 becomes equal to the output voltage E2 of the first DC power supply 30A. In other words, at the moment when the variable voltage E1 becomes equal to the output voltage E2, the multi-stage voltage power supply 3 is formed with the current paths C1′ and C2′ reverse to the paths C1 and C2.

During regeneration, when the system voltage Vout is increased across the output voltage E2+E3, that is, during switching from the two-stage connection to the three-stage connection, the switch controller 62A switches the sixth switch unit 36 and the eighth switch unit 38 from off to on, and then switches the fifth switch unit 35 and the eighth switch unit 38 from on to off. Further, during regeneration, when the system voltage Vout is lowered across the output voltage E2+E3, that is, during switching from the three-stage connection to the two-stage connection, the switch controller 62A switches the fifth switch unit 35 and the eighth switch unit 38 from off to on, and then switches the sixth switch unit 36 and the eighth switch unit 38 from on to off. In other words, the switch controller 62A temporarily turns on the fifth switch unit 35, the sixth switch unit 36, and the eighth switch unit 38 and turns off the seventh switch unit 37 during switching between the two-stage connection and the three-stage connection. Thus, it can realize the above-described overlap state only at the moment when the variable voltage E1 of the variable voltage power supply 7 becomes equal to the output voltage E3 of the second DC power supply 39. In other words, at the moment when the variable voltage E1 becomes equal to the output voltage E3, the multi-stage voltage power supply 3 is formed with current paths C3′ and ′C4 reverse to the current paths C3 and C4.

According to the power supply system 1A of the present embodiment, the following effects can be obtained in addition to the effects of (1) to (9) described above.

(11) The power supply system 1A includes the fifth diode 35a and the fifth switch 35b that are connected in parallel to the first power line 21 closer to the load 4 than the connection point of the first switch 31b and the third power line 23, the fifth power line 25 connected to the first power line 21 so as to bypass the fifth switch unit 35, and the second DC power supply 39 and the sixth switch 36b connected in series to the fifth power line 25. According to the present embodiment, when the sixth switch unit 36 is turned on, since the variable voltage power supply 7, the first DC power supply 30A, and the second DC power supply 39 are connected in series to the load 4 (three-stage connection), the number of stages of the system voltage Vout can be further increased.

(12) The power supply system 1A includes the sixth power line 26 that connects the fifth power line 25 closer to the variable voltage power supply 7 than the second DC power supply 39 and the sixth switch unit 36 and the third power line 23 between the first DC power supply 30A and the third switch unit 33, the seventh diode 37a and the seventh switch 37b that are connected in parallel to the fifth power line 25, and the eighth diode 38a and the eighth switch 38b that are connected in parallel to the sixth power line 26. According to the present embodiment, it is possible to prevent the current from flowing in an unintended direction during power running and during regeneration of the power supply system 1A.

In the present embodiment, the case has been described in which the variable voltage power supply 7 is used as the isolated bidirectional DC/DC converter described with reference to FIG. 2, but the present invention is not limited thereto. As described in the second embodiment, the front-stage converter 73 serving as an isolated bidirectional DC/DC converter and the rear-stage converter 80 serving as a bidirectional DC/DC converter may be used as the variable voltage power supply 7A by a combination in series.

### Fourth Embodiment

A vehicle as a moving body according to a fourth embodiment of the present invention will be described with reference to the drawings.

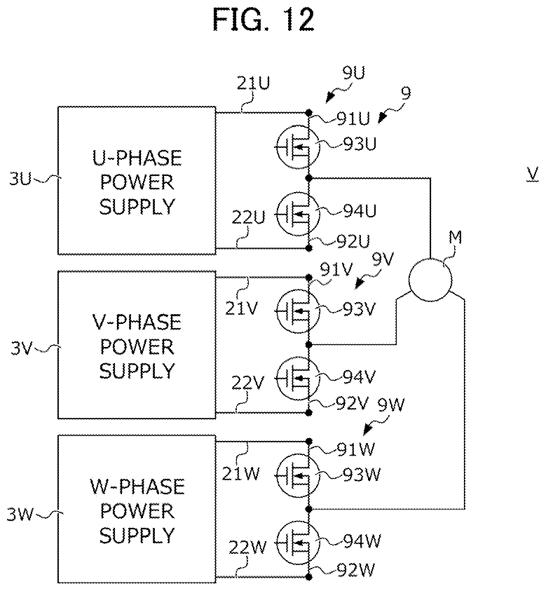

FIG. 12 is a diagram showing a circuit configuration of a vehicle V according to the present embodiment.

The vehicle V includes an AC rotating electrical machine M coupled to drive wheels (not shown) and generates a propulsive force for driving the vehicle V, a U-phase power supply 3U, a V-phase power supply 3V, a W-phase power supply 3W, and an inverter circuit 9 that connects the power supplies 3U, 3V, and 3W and the AC rotating electrical machine M. In the present embodiment, a case will be mainly described in which the vehicle V accelerates and decelerates by the power generated by the AC rotating electrical machine M, but the present invention is not limited thereto. The vehicle V may be a so-called hybrid vehicle equipped with the AC rotating electrical machine M and an engine as a power generation source.

The U-phase power supply 3U includes the multi-stage voltage power supply 3 according to the first embodiment, which is the three-level DC voltage power supply capable of outputting the DC voltage of three stages of 0, E1, and E1+E2 [V] from the power lines 21U and 22U, or the multi-stage voltage power supply 3A according to the third embodiment, which is the four-level DC voltage power supply capable of outputting the DC voltage of four stages of 0, E1, E1+E2, and E1+E2+E3 [V] from the power lines 21U and 22U.

The V-phase power supply 3V includes the multi-stage voltage power supply 3 according to the first embodiment, which is the three-level DC voltage power supply capable of outputting the DC voltage of three stages of 0, E1, and E1+E2 [V] from the power lines 21V and 22V, or the multi-stage voltage power supply 3A according to the third embodiment, which is the four-level DC voltage power supply capable of outputting the DC voltage of four stages of 0, E1, E1+E2, and E1+E2+E3 [V] from the power lines 21V and 22V.

Further, the W-phase power supply 3W includes the multi-stage voltage power supply 3 according to the first embodiment, which is the three-level DC voltage power supply capable of outputting the DC voltage of three stages of 0, E1, and E1+E2 [V] from the power lines 21W and 22W, or the multi-stage voltage power supply 3A according to the third embodiment, which is the four-level DC voltage power supply capable of outputting the DC voltage of four stages of 0, E1, E1+E2, and E1+E2+E3 [V] from the power lines 21W and 22W.

The AC rotating electrical machine M is coupled to the drive wheels through a power transmission mechanism (not shown). When three-phase AC power is supplied from the power supplies 3U, 3V, and 3W to the AC rotating electrical machine M, drive torque generated by the AC rotating electrical machine M is transmitted to the drive wheels through the power transmission mechanism (not shown) to rotate the drive wheels and to make the vehicle V run. Further, the AC rotating electrical machine M exerts a function of a generator during deceleration of the vehicle V, generates regenerative power, and applies regenerative braking torque according to a magnitude of the regenerative power to the drive wheels. The regenerative power generated by the AC rotating electrical machine M is appropriately charged in the battery of the power supplies 3U, 3V, and 3W.

The inverter circuit 9 includes a U-phase leg 9U connected to a U-phase of the AC rotating electrical machine M, a V-phase leg 9V connected to a V-phase of the AC rotating electrical machine M, and a W-phase leg 9W connected to a W-phase of the AC rotating electrical machine M.

The U-phase leg 9U includes a first U-phase power line 91U that connects a first power line 21U of the U-phase power supply 3U and the U-phase of the AC rotating electrical machine M, a second U-phase power line 92U that connects a second power line 22U of the U-phase power supply 3U and the U-phase of the AC rotating electrical machine M, a U-phase upper arm switching element 93U provided on the first U-phase power line 91U, and a U-phase lower arm switching element 94U provided on the second U-phase power line 92U. In other words, the power lines 21U and 22U of the U-phase power supply 3U, which is the multi-stage voltage power supply, are connected to both ends of the U-phase leg 9U, respectively.

The V-phase leg 9V includes a first V-phase power line 91V that connects a first power line 21V of the V-phase power supply 3V and the V-phase of the AC rotating electrical machine M, a second V-phase power line 92V that connects a second power line 22V of the V-phase power supply 3V and the V-phase of the AC rotating electrical machine M, a V-phase upper arm switching element 93V provided on the first V-phase power line 91V, and a V-phase lower arm switching element 94V provided on the second V-phase power line 92V. In other words, the power lines 21V and 22V of the V-phase power supply 3V, which is the multi-stage voltage power supply, are connected to both ends of the U-phase leg 9V, respectively.

The W-phase leg 9W includes a first W-phase power line 91W that connects a first power line 21W of the W-phase power supply 3W and the W-phase of the AC rotating electrical machine M, a second W-phase power line 92W that connects a second power line 22W of the W-phase power supply 3W and the W-phase of the AC rotating electrical machine M, a W-phase upper arm switching element 93W provided on the first W-phase power line 91W, and a W-phase lower arm switching element 94W provided on the second W-phase power line 92W. In other words, the power lines 21W and 22W of the W-phase power supply 3W, which is the multi-stage voltage power supply, are connected to both ends of the W-phase leg 9W, respectively.

According to the vehicle of the present embodiment, the following effect can be obtained.

(13) The vehicle V includes the AC rotating electrical machine M that generates the propulsive force and the U-phase power supply 3U, the V-phase power supply 3V, and the W-phase power supply 3W that are the multi-stage power supply capable of being switching between the one-stage connection and the two-stage connection as described above. In the vehicle V, the U-phase power supply 3U is connected to both ends of the U-phase leg 9U connected to the U-phase of the AC rotating electrical machine M, the V-phase power supply 3V is connected to both ends of the V-phase leg 9V connected to the V-phase of the AC rotating electrical machine M, and the W-phase power supply 3W is connected to both ends of the W-phase leg 9W connected to the W-phase of the AC rotating electrical machine M.

Therefore, according to the vehicle V, since it is not necessary to increase the number of arm switches included in the legs 9U, 9V, and 9W of respective phases when the voltage is increased in multiple stages, the switching loss and the steady loss in the legs 9U, 9V, and 9W of respective phases can be reduced accordingly. Further, according to the vehicle V, since the withstand voltage of the switches included in the power supplies 3U, 3V, and 3W of the respective phases can be lowered, the steady loss in the switches can be lowered, and the costs of the switches can also be reduced. Further, according to the vehicle V, since it is not necessary to operate the arm switches included in the legs 9U, 9V, and 9W of the respective phases in order to change the voltage during the high-voltage application (during two-stage connection or during three-stage connection), the high frequency component of the voltage applied to the AC rotating electrical machine M can be reduced, whereby the iron loss can also be reduced.

Although the embodiments of the present invention have been described above, the present invention is not limited thereto. Within the scope of the present invention, the detailed configuration may be changed as appropriate.

For example, in the above-described embodiments, the case has been described in which the full bridge isolated bidirectional DC/DC converter shown in FIG. 2 is used as the variable voltage power supply 7 and the front-stage converter 73, but the present invention is not limited thereto.

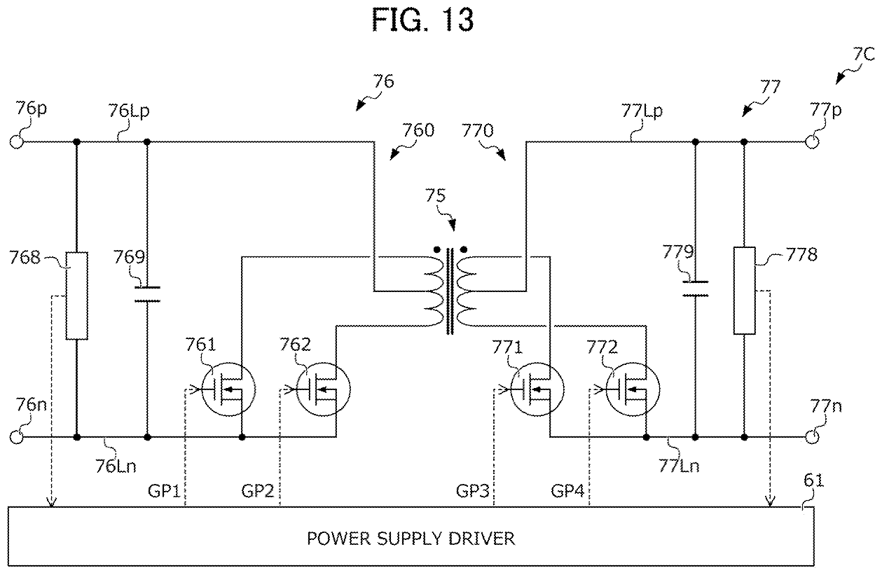

FIG. 13 is a diagram showing another example of the circuit configuration of the variable voltage power supply. FIG. 13 shows a case where a variable voltage power supply 7C is a so-called push-pull isolated bidirectional DC/DC converter.

The variable voltage power supply 7C includes an insulation transformer 75 having a primary coil and a secondary coil, a primary-side circuit 76 in which a primary side of the insulation transformer 75 is connected to a pair of primary-side input/output terminals 76p and 76n, and a secondary-side circuit 77 in which a secondary side of the insulation transformer 75 is connected to a pair of secondary-side input/output terminals 77p and 77n. As shown in FIG. 13, the insulation transformer 75 of the variable voltage power supply 7C is different from the insulation transformer 70 of the variable voltage power supply 7 shown in FIG. 2 in that both of the primary coil and the secondary coil are a center tap type.

The primary-side circuit 76 includes a positive electrode power line 76Lp that connects the primary-side positive electrode input/output terminal 76p and a center tap of the primary coil of the insulation transformer 75, a negative electrode power line 76Ln connected to the primary-side negative electrode input/output terminal 76n, a primary-side synchronous full-wave rectifier circuit 760 that connects these power lines 76Lp and 76Ln and the primary coil of the insulation transformer 75, and a primary-side voltage sensor 768 and a smoothing capacitor 769 that are connected to each other in parallel between the positive electrode power line 76Lp and the negative electrode power line 76Ln.

The primary-side synchronous full-wave rectifier circuit 760 includes a first switching element 761 that connects one end side of the primary coil of the insulation transformer 75 and the negative electrode power line 76Ln, and a second switching element 762 that connects the other end side of the primary coil of the insulation transformer 75 and the negative electrode power line 76Ln. Each of these switching elements 761 and 762 is switched on or off according to on/off of the gate drive signals GP1 and GP2 input from the power supply driver 61. In the example shown in FIG. 13, the case has been described in which an N-channel MOSFET including a body diode, which allows a current from a source to a drain, is used as these switching elements 761 and 762, but the present invention is not limited thereto. As these switching elements 761 and 762, a known switching element such as an IGBT or a JFET may be used in addition to the MOSFET.

Drains of the switching elements 761 and 762 are connected to both ends of the primary coil of the insulation transformer 75, respectively, and sources of the switching elements 761 and 762 are connected to the negative electrode power line 76Ln.

The secondary-side circuit 77 includes a positive electrode power line 77Lp that connects the secondary-side positive electrode input/output terminal 77p and a center tap of the secondary coil of the insulation transformer 75, a negative electrode power line 77Ln connected to the secondary-side negative electrode input/output terminal 77n, a secondary-side synchronous full-wave rectifier circuit 770 that connects these power lines 77Lp and 77Ln and the secondary coil of the insulation transformer 75, and a secondary-side voltage sensor 778 and a smoothing capacitor 779 that are connected to each other in parallel between the positive electrode power line 77Lp and the negative electrode power line 77Ln.

The secondary-side synchronous full-wave rectifier circuit 770 includes a first switching element 771 that connects one end side of the secondary coil of the insulation transformer 75 and the negative electrode power line 77Ln, and a second switching element 772 that connects the other end side of the secondary coil of the insulation transformer 75 and the negative electrode power line 77Ln. Each of these switching elements 771 and 772 is switched on or off according to on/off of the gate drive signals GP3 and GP2 input from the power supply driver 61. In the example shown in FIG. 13, the case has been described in which an N-channel MOSFET including a body diode, which allows a current from a source to a drain, is used as these switching elements 771 and 772, but the present invention is not limited thereto. As these switching elements 771 and 772, a known switching element such as an IGBT or a JFET may be used in addition to the MOSFET.

Drains of the switching elements 771 and 772 are connected to both ends of the primary coil of the insulation transformer 75, respectively, and sources of the switching elements 771 and 772 are connected to the negative electrode power line 77Ln.

What is claimed is:

1. A power supply system comprising: a variable voltage power supply that outputs power of a variable voltage from a pair of first terminals; and
a first power line and a second power line that connect the pair of first terminals and a load, wherein
the first power line is provided with a first switch and a third power line that connects both ends of the first switch, and
the third power line is provided with a first DC power supply, which outputs DC power, and a second switch which are connected to each other in series.

2. The power supply system according to claim 1, further comprising: a fourth power line that connects the third power line closer to the variable voltage power supply than the first DC power supply and the second switch and the second power line; and
a third switch provided closer to the variable voltage power supply of the third power line than a connection point of the fourth power line, wherein
the fourth power line is provided with a fourth diode that allows an output current of the first DC power supply and cuts off a current reverse to the output current.

3. The power supply system according to claim 2, wherein a first diode and the first switch are connected in parallel to the first power line, the first diode being configured to allow the output current of the variable voltage power supply and cut off the current reverse to the output current,
a third diode and the third switch are connected in parallel to the third power line, the third diode being configured to cut off the output current of the first DC power supply and allow the current reverse to the output current, and
the fourth diode and a fourth switch are connected in parallel to the fourth power line.

4. The power supply system according to claim 3, further comprising a power supply driver that changes a voltage between the pair of first terminals from 0 to a predetermined maximum voltage by operating the variable voltage power supply.

5. The power supply system according to claim 3, further comprising a switch controller that controls the first, second, third, and fourth switches based on a system voltage, which is a voltage between the first and second power lines.

6. The power supply system according to claim 5, wherein, during power running in which power in the first and second power lines is supplied to the load,
the switch controller turns off the second, third, and fourth switches when changing the system voltage in a range less than a first voltage of the first DC power supply, and
the switch controller turns on the second and third switches and turns off the first and fourth switches when changing the system voltage in a range larger than the first voltage.

7. The power supply system according to claim 6, wherein, during the power running,
the switch controller switches the second switch from off to on, and then switches the third switch from off to on when raising the system voltage across the first voltage, and
the switch controller switches the third switch from on to off, and then switches the second switch from on to off when lowering the system voltage across the first voltage.

8. The power supply system according to claim 5, wherein, during regeneration in which the power in the load is supplied to the first and second power lines,
the switch controller turns on the first switch and turns off the second, third, and fourth switches when changing the system voltage in the range less than the first voltage of the first DC power supply, and
the switch controller turns on the second switch and turns off the first and fourth switches when changing the system voltage in the range larger than the first voltage.

9. The power supply system according to claim 8, wherein, during the regeneration,
the switch controller switches the second and fourth switches from off to on and then switches the first and fourth switches from on to off when raising the system voltage across the first voltage, and
the switch controller switches the first and fourth switches from off to on and then switches the second and fourth switches from on to off when lowering the system voltage across the first voltage.

10. The power supply system according to claim 4, further comprising a switch controller that controls the first, second, third, and fourth switches based on a system voltage, which is a voltage between the first and second power lines.

11. The power supply system according to claim 5, wherein, during power running in which power in the first and second power lines is supplied to the load,
the switch controller turns off the second, third, and fourth switches when changing the system voltage in a range less than a first voltage of the first DC power supply, and
the switch controller turns on the second and third switches and turns off the first and fourth switches when changing the system voltage in the range larger than the first voltage.

12. The power supply system according to claim 6, wherein, during the power running,
the switch controller switches the second switch from off to on, and then switches the third switch from off to on when raising the system voltage across the first voltage, and
the switch controller switches the third switch from on to off and then switches the second switch from on to off when lowering the system voltage across the first voltage.

13. The power supply system according to claim 10, wherein, during regeneration in which the power in the load is supplied to the first and second power lines,
the switch controller turns on the first switch and turns off the second, third, and fourth switches when changing the system voltage in the range less than the first voltage of the first DC power supply, and
the switch controller turns on the second switch and turns off the first and fourth switches when changing the system voltage in the range larger than the first voltage.

14. The power supply system according to claim 13, wherein, during the regeneration,
the switch controller switches the second and fourth switches from off to on and then switches the first and fourth switches from on to off when raising the system voltage across the first voltage, and
the switch controller switches the first and fourth switches from off to on and then switches the second and fourth switches from on to off when lowering the system voltage across the first voltage.

15. The power supply system according to claim 3, wherein a fifth diode and a fifth switch are connected in parallel to the first power line closer to the load than a connection point of the first switch and the third power line, the fifth diode being configured to allow the output current of the variable voltage power supply and cut off the current reverse to the output current,
the first power line is provided with a fifth power line that connects the fifth diode and both ends of the fifth switch, and
a second DC power supply for outputting DC power and a sixth switch are connected in series to the fifth power line.

16. The power supply system according to claim 15, further comprising a sixth power line that connects the fifth power line closer to the variable voltage power supply than the second DC power supply and the sixth switch and the third power line between the first DC power supply and the third switch, wherein
a seventh diode and a seventh switch are connected in parallel to the fifth power line closer to the variable voltage power supply than a connection point with the sixth power line, the seventh diode being configured to cut off an output current of the second DC power supply and allow a current reverse to the output current, and
an eighth diode and an eighth switch are connected in parallel to the sixth power line, the eighth diode being configured to allow the output current of the second DC power supply and cut off the current reverse to the output current.

17. The power supply system according to claim 4, wherein a fifth diode and a fifth switch are connected in parallel to the first power line closer to the load than a connection point of the first switch and the third power line, the fifth diode being configured to allow the output current of the variable voltage power supply and cut off the current reverse to the output current,
the first power line is provided with a fifth power line that connects the fifth diode and both ends of the fifth switch, and
a second DC power supply for outputting DC power and a sixth switch are connected in series to the fifth power line.

18. The power supply system according to claim 17, further comprising a sixth power line that connects the fifth power line closer to the variable voltage power supply than the second DC power supply and the sixth switch and the third power line between the first DC power supply and the third switch, wherein
a seventh diode and a seventh switch are connected in parallel to the fifth power line closer to the variable voltage power supply than a connection point with the sixth power line, the seventh diode being configured to cut off an output current of the second DC power supply and allow a current reverse to the output current, and
an eighth diode and an eighth switch are connected in parallel to the sixth power line, the eighth diode being configured to allow an output current of the second DC power supply and cut off a current reverse to the output current.

19. A moving body comprising: an AC rotating electrical machine that generates a propulsive force;
a U-phase power supply that is the power supply system according to claim 1;
a V-phase power supply that is the power supply system according to claim 1; and
a W-phase power supply that is the power supply system according to claim 1, wherein
the U-phase power supply is connected to both ends of a U-phase leg connected to a U-phase of the AC rotating electrical machine,
the V-phase power supply is connected to both ends of a V-phase leg connected to a V-phase of the AC rotating electrical machine, and
the W-phase power supply is connected to both ends of a W-phase leg connected to a W-phase of the AC rotating electrical machine.

20. A moving body comprising: an AC rotating electrical machine that generates a propulsive force;
a U-phase power supply that is the power supply system according to claim 2;
a V-phase power supply that is the power supply system according to claim 2; and
a W-phase power supply that is the power supply system according to claim 2, wherein
the U-phase power supply is connected to both ends of a U-phase leg connected to a U-phase of the AC rotating electrical machine,
the V-phase power supply is connected to both ends of a V-phase leg connected to a V-phase of the AC rotating electrical machine, and
the W-phase power supply is connected to both ends of a W-phase leg connected to a W-phase of the AC rotating electrical machine.
